(19) United States
(12) Patent Application Publication
(10) Pub. No.: US 2026/0102903 A1
(43) Pub. Date: Apr. 16, 2026

(54) SENSORS OF A HUMANOID ROBOT

(71) Applicant: Figure AI Inc., San Jose, CA (US)

(72) Inventors: Marc Baroudi, San Jose, CA (US); Keyvan Yeganeh, San Jose, CA (US); Michael Stevens, San Jose, CA (US); Jake Goldsmith, San Jose, CA (US); Keith Wakeham, San Jose, CA (US); Jose Domingo Briones Bravo, San Jose, CA (US)

(21) Appl. No.: 19/355,786

(22) Filed: Oct. 10, 2025

Related U.S. Application Data
(63) Continuation-in-part of application No. 19/347,690, filed on Oct. 1, 2025.
(60) Provisional application No. 63/705,715, filed on Oct. 10, 2024.
(60) Provisional application No. 63/706,768, filed on Oct. 14, 2024.
(60) Provisional application No. 63/828,916, filed on Jun. 23, 2025.

(51) Int. Cl. B25J 9/00; B25J 9/16; B25J 15/00; B25J 19/02

(52) U.S. Cl. CPC B25J 9/0015; B25J 9/1697; B25J 15/0009; B25J 19/023

(57) ABSTRACT

The present disclosure provides a bipedal robot comprising a torso, head, arm assembly, and end effector. The end effector includes a thumb assembly with at least three degrees of freedom, a first finger assembly with at least two degrees of freedom, a vision sensor positioned between the arm assembly's distal end and first finger assembly, and an illumination source. The illumination source illuminates the field of view between the vision sensor and the thumb and first finger assembly extents when the robot is extended. The vision sensor's field of view includes most of the end effector's palmer side, enabling detection of contact information between objects and the thumb assembly and first finger assembly extents.

### CROSS REFERENCE TO RELATED APPLICATIONS

This application is: (i) a continuation-in-part of U.S. patent application Ser. No. 19/347,690, filed Oct. 1, 2025, and (ii) claims the benefit of and priority to U.S. Provisional Patent Application Nos. 63/705,715, filed Oct. 10, 2024, 63/706,768, filed Oct. 14, 2024, and 63/828,916 filed Jun. 23, 2025, each of which is expressly incorporated by reference herein in its entirety.

### TECHNICAL FIELD

This disclosure relates to sensors for a humanoid robot, and specifically to sensors that gather data from the environment external to said humanoid robot.

### BACKGROUND

Humanoid robots are designed to operate in and interact with complex, human-centric environments. To navigate and perform tasks effectively, these robots rely on a variety of sensors to perceive their surroundings. Vision systems, typically comprising one or more cameras, are fundamental components of a robot's perception system. Conventionally, these vision systems are located in the robot's head, often arranged in a horizontal configuration to mimic the binocular vision of humans and facilitate stereo depth perception. While this approach is common, it presents several limitations. For instance, the robot's own arms, hands, or any objects it carries can obstruct the field of view of head-mounted cameras, creating significant blind spots. To see objects near its own body or to look around such obstructions, a robot may be required to make large, inefficient, and potentially slow movements of its head, neck, or torso. Furthermore, the integration of commercially available, pre-packaged sensor systems can impose design constraints. These systems may occupy considerable volume within the robot's head, limiting space for other essential electronics. They can also contribute to increased power consumption, heat generation, and potential supply chain vulnerabilities. Therefore, there exists a need for an improved sensor architecture for a humanoid robot that provides a more comprehensive field of view, mitigates blind spots created by the robot's own limbs, and offers a more efficient and integrated solution than conventional systems.

### SUMMARY OF INVENTION

The presently disclosed subject matter is directed to a bipedal robot comprising a torso, a head coupled to the torso, an arm assembly coupled to the torso, and an end effector coupled to the arm assembly. The end effector includes a thumb assembly coupled to a first portion of the end effector, a first finger assembly coupled to a second portion of the end effector, a sensor mounting frame coupled to a third portion of the end effector that is positioned between a distal extent of the arm and a majority of the first finger assembly, and a vision sensor mounted to the sensor mounting frame and including an imaging detector, a lens that overlies and protects the imaging detector, and an illumination source positioned near the image detector and configured to illuminate a spatial region between the imaging detector and a distal end of the first finger assembly.

The presently disclosed subject matter is directed to a bipedal robot comprising a torso, a head coupled to the torso, an arm assembly coupled to the torso at a proximal end of the arm assembly, and an end effector coupled to the arm assembly at a distal end of the arm assembly. The end effector has a palmer side and a dorsal side and includes a thumb assembly having at least three degrees of freedom, a first finger assembly having at least two degrees of freedom, a vision sensor positioned between a distal end of the arm assembly and the first finger assembly, and an illumination source arranged to illuminate at least a majority of the field of view between the vision sensor and the extent of the thumb and the extent of the first finger assembly, as determined while the humanoid robot is in an extended state. The vision sensor is configured to have a field of view that includes a majority of the palmer side of said end effector, and whereby said field of view enables the vision sensor to detect information about contact between an object and one or more of an extent of the thumb assembly and an extent of the first finger assembly.

The presently disclosed subject matter is directed to a bipedal robot comprising a torso, a head coupled to the torso, an arm assembly coupled to the torso, and an end effector coupled to the arm assembly. The end effector includes a first finger assembly having a respective operational space and a first energy attenuation member affixed to a portion of the first finger assembly, a thumb assembly positioned adjacent to the first finger assembly and having a respective operational space and a second energy attenuation member affixed to a portion of the thumb assembly, and a vision sensor positioned near both the thumb assembly and the finger assembly and having a field of view that includes the respective operational space of the first finger and at least a majority of the respective operational space of the thumb.

The presently disclosed subject matter is directed to a humanoid robot. Particularly, the robot comprises a head assembly including a housing having curvilinear exterior surfaces and lacking pronounced human facial structures. The robot includes a sensor assembly positioned within the head assembly and including an upper camera positioned in a forehead region of the head assembly, a lower camera positioned in a chin region of the head assembly, a top camera positioned on a top of the head assembly, and a rear camera positioned on a rear of the head assembly, wherein the upper camera, lower camera, top camera, and rear camera are vertically aligned in a sagittal plane of the humanoid robot. The robot includes a computing device operatively coupled to the sensor assembly and configured to integrate data from the upper camera and lower camera using a custom-built algorithm to extract three-dimensional information from collected data.

The presently disclosed subject matter is directed to a method of providing environmental sensing for a humanoid robot. Particularly, the method comprises positioning a first camera in a forehead region of a head assembly of the humanoid robot. The method includes positioning a second camera in a chin region of the head assembly. The method includes positioning a third camera on a top of the head assembly. The method includes positioning a fourth camera on a rear of the head assembly, wherein the first camera, second camera, third camera, and fourth camera are vertically aligned in a sagittal plane of the humanoid robot. The method includes capturing image data from each of the first camera, second camera, third camera, and fourth camera. The method includes processing the captured image data using a custom-built algorithm to integrate data from the first camera and second camera into stereo vision information.

The presently disclosed subject matter is directed to a sensor system for a humanoid robot. Particularly, the system comprises a head-mounted sensor assembly including multiple cameras arranged in a vertical configuration within a sagittal plane of the humanoid robot, the multiple cameras including an upper camera directed substantially forward, a lower camera directed substantially forward, a top camera directed substantially upward, and a rear camera directed substantially rearward. The system includes an end effector sensor assembly including an end effector camera positioned on a palm of an end effector and directed toward thumb and finger assemblies of the end effector. The system includes a processor configured to process data from the head-mounted sensor assembly and the end effector sensor assembly to provide environmental awareness for the humanoid robot.

The presently disclosed subject matter is directed to a humanoid robot end effector assembly. Particularly, the assembly comprises an end effector housing including a palm, a back, left and right sides, and a front. The assembly includes a thumb assembly and at least one finger assembly coupled to the end effector housing and movable between an open state and a curled state. The assembly includes an end effector camera positioned on the palm of the end effector housing and directed toward the thumb assembly and the at least one finger assembly such that the thumb assembly and the at least one finger assembly are within a field of view of the end effector camera. The assembly includes tactile sensor assemblies housed within the thumb assembly and the at least one finger assembly and configured to measure load experienced on the thumb assembly and the at least one finger assembly using strain gauges.

The presently disclosed subject matter is directed to a method of controlling a humanoid robot using distributed sensing. Particularly, the method comprises capturing first image data from cameras positioned in a head assembly of the humanoid robot, the cameras including an upper camera in a forehead region, a lower camera in a chin region, a top camera on a top of the head assembly, and a rear camera on a rear of the head assembly. The method includes capturing second image data from an end effector camera positioned on a palm of an end effector of the humanoid robot and directed toward finger assemblies of the end effector. The method includes processing the first image data and second image data to identify objects and environmental features. The method includes controlling movement of the humanoid robot based on the processed first image data and second image data to perform manipulation tasks while minimizing blind spots.

The presently disclosed subject matter is directed to a humanoid robot arm assembly. Particularly, the assembly comprises a lower forearm including a forearm camera mounted thereto and directed toward an end effector. The assembly includes a wrist coupled to the lower forearm and including a wrist camera mounted thereto and directed toward the end effector. The assembly includes the end effector coupled to the wrist and including an end effector camera positioned on a palm of the end effector and directed toward thumb and finger assemblies of the end effector. The assembly includes a control system configured to process image data from the forearm camera, wrist camera, and end effector camera to provide multiple fields of view for manipulation tasks.

The presently disclosed subject matter is directed to a sensor configuration for a humanoid robot. Particularly, the configuration comprises a plurality of cameras positioned at different locations on the humanoid robot and configured to minimize blind spots, the plurality of cameras including head-mounted cameras arranged vertically in a sagittal plane, arm-mounted cameras directed toward end effectors, and end effector-mounted cameras directed toward finger assemblies. The configuration includes sensor openings formed in housings of the humanoid robot and configured to receive lenses of the plurality of cameras without obstruction. The configuration includes a processing system configured to combine image data from the plurality of cameras to provide comprehensive environmental sensing for the humanoid robot during locomotion and manipulation tasks.

In some embodiments, a humanoid robot is equipped with a head-mounted sensor assembly comprising an upper camera and a lower camera, both positioned at a downward angle of about 6.0 to 9.0 degrees with respect to a horizontal plane. The assembly also includes a top camera directed substantially upward and a rear camera positioned at a downward angle of about 14 to 22 degrees. A processing system utilizes a custom-built algorithm to integrate data from the vertically-aligned upper and lower cameras into stereo vision information. This configuration is configured to recover at least 10% of space within the head assembly and reduce heat generation, latency, and power consumption compared to commercially available, horizontally spaced stereo vision sensors. The control system may adjust the head assembly's pitch by approximately ±25 degrees to allow the cameras to view the areas immediately in front of and behind the robot's feet.

In some embodiments, the system further comprises arm and end-effector-mounted cameras to provide comprehensive awareness during manipulation tasks. An arm sensor assembly includes a forearm camera and a wrist camera, both directed toward the end effector to provide overlapping fields of view that minimize blind spots. The end effector includes a camera positioned on the palm at a downward angle of about 45 to 70 degrees with respect to the horizontal plane and at an angle of about 12 to 19 degrees with respect to a vertical plane. The image data from the head, arm, and end-effector cameras are combined by a control system, which can adjust the arm's positioning to maintain continuous object tracking when the end effector might otherwise obstruct the view of the head-mounted cameras.

In some embodiments, the end effectors include thumb and finger assemblies, for instance, a thumb with four degrees of freedom and fingers with three degrees of freedom. To enable delicate touch control, these assemblies are equipped with tactile sensor assemblies located at the distal ends. These sensors utilize strain gauges configured in quarter-bridge, half-bridge, or full-bridge configurations to measure force, stress, torque, pressure, and deflection. The strain gauges may be foil-type, made from materials such as constantan, karma, or nichrome alloys, with carriers made from polyimide film or epoxy resin. The control system is configured to integrate the tactile feedback data from these strain gauges with the visual data from the multiple camera systems to enable precise manipulation of objects during complex tasks.

### BRIEF DESCRIPTION OF THE DRAWINGS

The drawing figures depict one or more implementations in accordance with the present teachings, by way of example only, and not by way of limitation. These figures are intended to illustrate, and not to restrict, the scope of the disclosure. In the figures, like reference numerals refer to the same or similar elements. This convention is maintained throughout the drawings for consistency.

FIG. 1 is a diagram illustrating an environment and a network in which one or more humanoid robots may operate, connect, command and/or be commanded by, control and/or be controlled by, and/or interact;

FIG. 2 is a block diagram illustrating components of the humanoid robot of FIGS. 1 and 5;

FIG. 3 is a block diagram of sensors for the humanoid robot of FIGS. 1, 2, and 5;

FIG. 4 is a block diagram of a communication interface for the humanoid robot of FIGS. 1, 2, and 5;

FIG. 5 is a perspective view of a humanoid robot of FIGS. 1-2;

FIG. 6 is a perspective view of the robot of FIG. 1, wherein all components of the robot have been removed except for the collection of sensors that are designed to obtain data directly from interactions with objects (e.g., tactile) or through observing objects (e.g., cameras);

FIG. 7 is a front view of the sensor collection of the robot of FIG. 6;

FIG. 8 is a top view of the sensor collection of the robot of FIG. 6;

FIG. 9 is a side view of the sensor collection of the robot of FIG. 6;

FIG. 10 is a perspective view of the sensors contained in the head and neck assembly of the humanoid robot;

FIG. 11 is a front view of the sensors of FIG. 10;

FIG. 12 is a top view of the sensors of FIG. 10;

FIG. 13 is a perspective view showing the blind spots of the humanoid robot of FIGS. 1, 2, and 5, wherein said humanoid robot is in an extended position;

FIG. 14 is a side view of the humanoid robot in the neutral position with the associated field of views and line of sights of the external data gathering sensors shown in FIG. 11;

FIG. 15 is a side view of the head and neck assembly and shows the field of views and line of sights that are associated with each external data gathering sensor contained within said head and neck assembly;

FIG. 16 is a side view of the head and neck assembly and shows the angle of the line of sight of each external data gathering sensor relative to horizontal planes;

FIG. 17 is a side view of the humanoid robot with its head and neck assembly in a maximum cervical extension, and showing the field of views and line of sights of the external data gathering sensors shown in FIG. 14;

FIG. 18 is a side view of the humanoid robot with its head and neck assembly in a maximum cervical flexion, and showing the field of views and line of sights of the external data gathering sensors shown in FIG. 14;

FIG. 20 is a top view of the humanoid robot in the neutral position with the associated field of views and line of sights of the external data gathering sensors shown in FIG. 13;

FIG. 21 is a top view of the humanoid robot in the neutral position and shows the angle of the line of sight of each external data gathering sensor relative to vertical planes;

FIG. 22 is a top view of the humanoid robot with its head and neck assembly in a maximum lateral left extension, and showing the field of views and line of sights of the external data gathering sensors shown in FIG. 13;

FIG. 23 is a perspective view of one of the end effectors included in the robot of FIG. 1, which includes (a) an end effector housing, (b) a thumb assembly, (c) at least one finger assembly, and (d) an electronics package for controlling the same, wherein the electronics package includes an end effector sensor assembly housed in the palm of the end effector housing and finger sensor assemblies housed in the thumb and finger assemblies;

FIG. 24 is a back, rear perspective view of the end effector of FIG. 26, wherein the end effector housing of the end effector has been removed to show the end effector sensor assembly includes at least one end effector camera;

FIG. 25 is a frontal, back perspective view of the end effector of FIG. 24;

FIG. 26 is a palm-based perspective view of the end effector of FIG. 24;

FIG. 27 is a side view of the end effector of FIG. 24;

FIG. 28 is a front view of the end effector of FIG. 24;

FIG. 29 illustrates an image obtained by the end effector vision sensor of FIG. 23, showing the thumb and finger assemblies are within the field of view when in a first partially curled state;

FIG. 30 illustrates an image obtained by the end effector vision sensor of FIG. 23, showing the thumb and finger assemblies are within the field of view when in a second partially curled state;

FIG. 31 illustrates an image obtained by the end effector vision sensor of FIG. 23, showing the thumb and finger assemblies are within the field of view when in a third partially curled state; and

FIG. 32 shows an alternative embodiment, wherein the sensor can be placed at any location along the arm of the humanoid robot;

FIG. 33 illustrates a comparison of images obtained by the head-mounted vision sensors and the end effector vision sensor of FIG. 23.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such a feature is required in all embodiments and, in some embodiments, may not be included or may be combined with other features.

### A. Introduction

The sensors disclosed in this Application are designed to be components within a robot system, potentially a versatile humanoid robot. The sensors may be contained in various components of the robot including the head, arms, and end effectors to detect information regarding at least the environment surrounding the robot. Unlike conventional robots, said sensors have a simplified arrangement to detect significant information without requiring continuous processing of extraneous information. Although the robot may include additional sensors for various purposes (e.g., position or relative position of components), detailed herein are the sensor assemblies contained in the head, arms, and end effectors for sensing the environment surrounding the robot.

The disclosed head has an overall shape that generally resembles a human head. As such, the head does not include large flat surfaces (e.g., opposed sides of a head, or is not in the shape of: (a) a cube, (b) a hexagonal prism, or (c) a pentagonal prism). Instead, almost all the surfaces in said robot head are curvilinear or have a curvilinear aspect. However, as shown in the Figures, the head does include a recess with a small flat sensor cover or lens. Said flat sensor cover or lens is recessed in the head and is designed to decrease sensor signal distortion that may be caused if said sensor signals are required to travel through a curvilinear cover, shield, or lens. Additionally, while said overall head shape is designed to be human-like, the disclosed head lacks human facial structures (cheeks, eye sockets, or other moving structures). The head enclosure may be injection molded, thermoformed, or 3D printed, wherein said outer shell may include any known polymer material, including urethanes, PMMA, ABS, nylons, polyamides, etc.

Unlike conventional robot heads, the disclosed head includes a plurality of sensors to provide a fuller field of view of the environment surrounding the robot and help minimize blind spots. The first sensor is positioned within the robot's forehead region, while the second sensor is positioned within the robot's chin region. Additionally, the robot's head has a third sensor positioned on the rear of the head and a fourth sensor positioned on top of the head. The position of the first sensor: (i) enables a larger screen to be utilized within the head, and (ii) allows the robot to see into a bin that is placed on a high shelf. Including the second sensor enables the robot to see what it is carrying (including looking into a bin) without using the first sensor. This is beneficial over conventional robots that lack the second sensor because said conventional robots must bend and turn their neck more to obtain the data captured from said second sensor. The position of the third sensor provides the robot with additional information of the environment behind it to help with situational awareness and localization of the robot. Similarly, the fourth camera is positioned on the top of the head to assist with localization of the robot. None of the sensors are positioned where a human's eyes would typically be located, nor on either side of the robot's head.

The upper, lower, top, and rear sensors in the head are all vertically aligned in the sagittal plane and are directly coupled to a computing device (e.g., processor) that can be located in the head of the robot, wherein said computing device is running a custom-built algorithm to integrate the data from the forehead and chin sensor assemblies (e.g., cameras) into stereo vision or to extract 3D information from the collected data. The vertical camera arrangement allows freedom to minimize the space required by the cameras; thus, allowing more room for other electronics within the head. For example, the placement of the sensors can recover at least 10% of the space that was used by commercially available (e.g., RealSense by Intel) stereo vision sensors. In other words, the robot lacks commercially available sensors (e.g., RealSense by Intel or other pre-packaged camera systems) that include horizontally spaced cameras. In addition to recovering said space by omitting said commercially available sensors, the vertical arrangement of the sensor assemblies with the custom-built algorithms reduces heat generation, removes supply issues, reduces latency, and reduces power consumption.

In addition to the sensors in the head of the robot, the disclosed end effectors include at least one sensor to provide closer views of the environment the robot is interacting with and help further minimize blind spots. The end effector sensor is positioned on the palm of the end effector and directed toward the thumb and finger assemblies of the end effector. The disclosed arms of the robot may also include sensors that are directed toward the thumb and finger assemblies of the end effector. The sensor may be positioned on the forearm and/or the wrist of the robot's arm. Unlike conventional robots, the end effector, forearm, and wrist sensors provide different fields of view of the environment surrounding the robot and help minimize blind spots. For example, when the robot picks up an object or moves its arms, the object and/or arms may obstruct the head sensors and create blind spots. The end effector, forearm, and wrist sensors enable the robot to view these areas and provide a fuller field of view for the robot.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., end effectors with over ten degrees of freedom), nor do its components need to have a shape that exactly or substantially resembles human parts. Furthermore, it should be understood that a humanoid robot is not designed to be primarily quadruped or have a wheeled base.

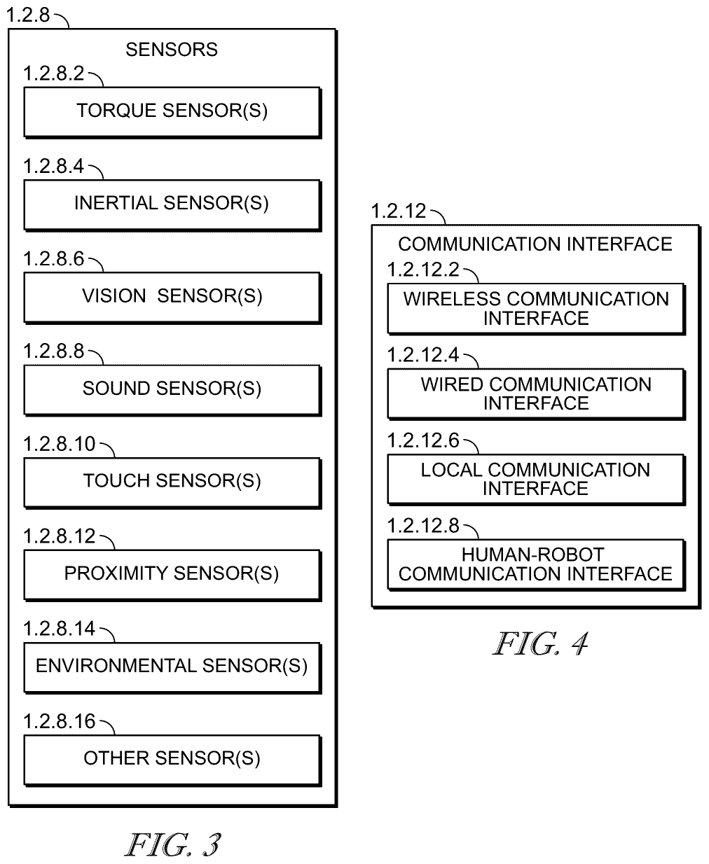

Neutral State: a state where the robot is standing upright on a horizontal support surface (PG) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the end effectors are oriented with the palms facing substantially inward, and the fingers pointing in a substantially downward direction toward the horizontal support surface. An illustrative example of the neutral state for the humanoid robot 1 is shown in FIG. 3A.

Extended State: a state of the robot with the arms extended outward laterally at the shoulder (as illustrated in FIG. 3B) and oriented with the palms of the end effectors substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (Ps) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (Ps) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contain an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (Pc) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁)) and rotational axis A₁₀ of torso twist actuator (J10) located in the spine 60 of the robot 1. As shown in these figures, the coronal plane (Pc) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (Cₚ) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearings or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define the orientation of the rotational axes and/or relative size of the individual actuator.

Actuator bearing plane (Bₙ): a plane defined mid-width of the actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

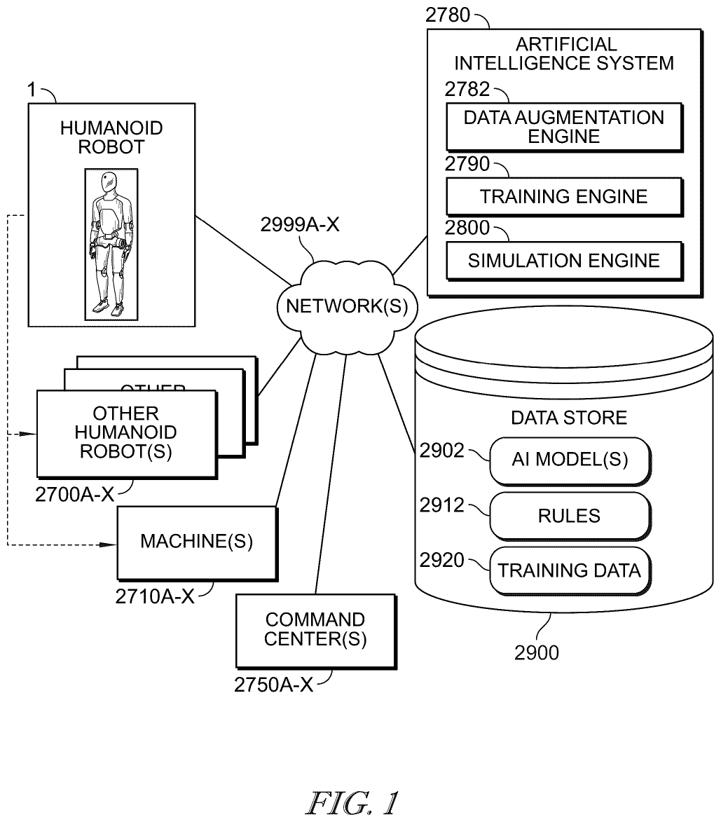

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may be the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-based AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands of AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. Humanoid Robot

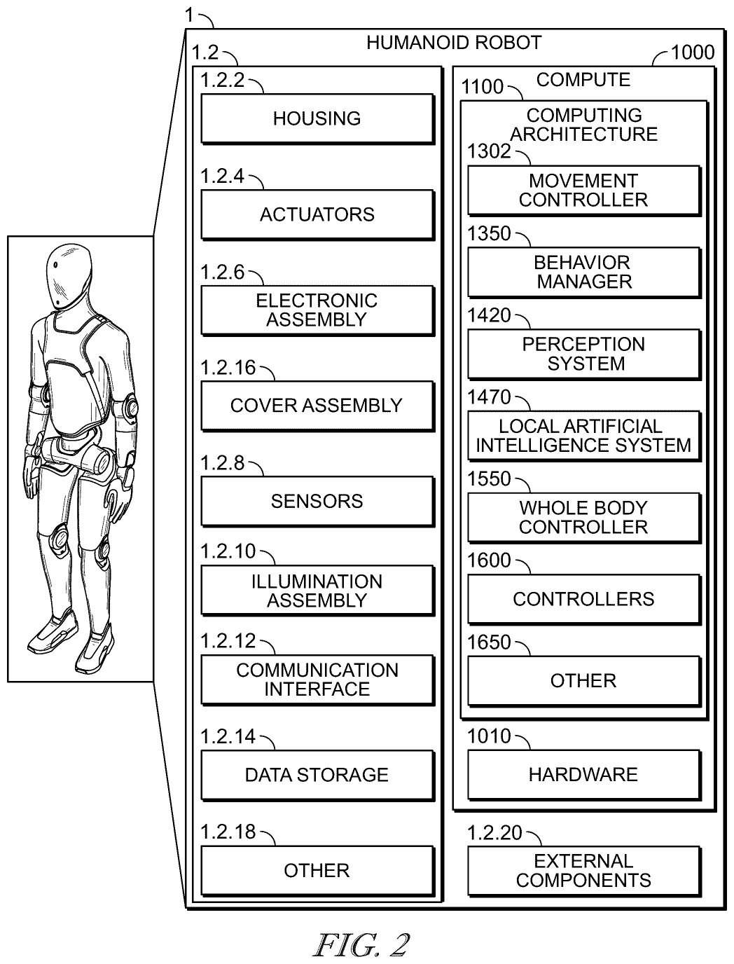

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, cover system 1.2.16, external components 1.2.20, other components 1.2.18, and (ii) compute 1000 that includes a computing architecture 1100 including instructions to be executed on computing hardware 1010 comprising at least one processor.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right end effectors 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The end effector 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

a. Housing

The housing 102 of head and neck assembly 10 is configured to contain and protect the assemblies coupled to an internal support assembly 104 contained within the head 10. The housing 102 is configured to have a form resembling the general shape of a human head and includes an enclosure 102.2, a frontal shield 102.4, a gorget interface 102.6, and a neck shell 102.8. The head enclosure 102.2 includes a front cover 102.2.2 and a rear cover 102.2.4 to contain and protect the electronics assembly 108 coupled to the internal support frame 104 and at least a portion of a coupling assembly and the head nod actuator (J8.2) 140 coupled thereto. In other embodiments, the head enclosure may have more components assembled together to contain and protect the components within the head 10. The modular design allows for individual components to be replaced without requiring replacement of the entire housing. The housing 102 may be injection molded or 3D printed and may include any known polymer material, including urethanes, PMMA, ABS, nylons, polyamides, etc.

i. Front Cover Assembly

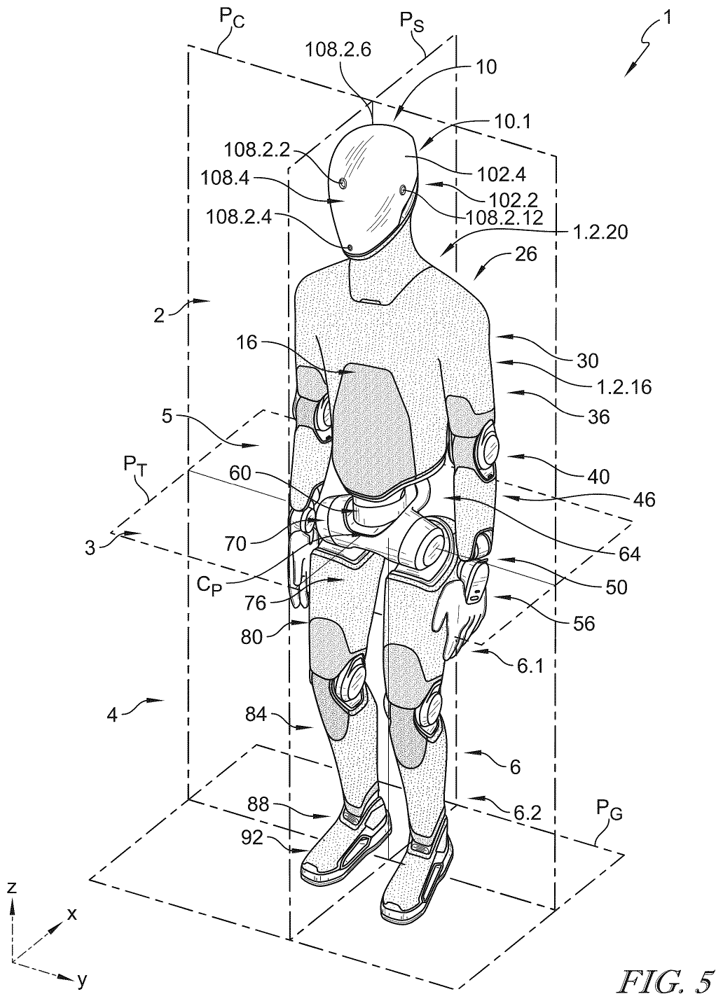

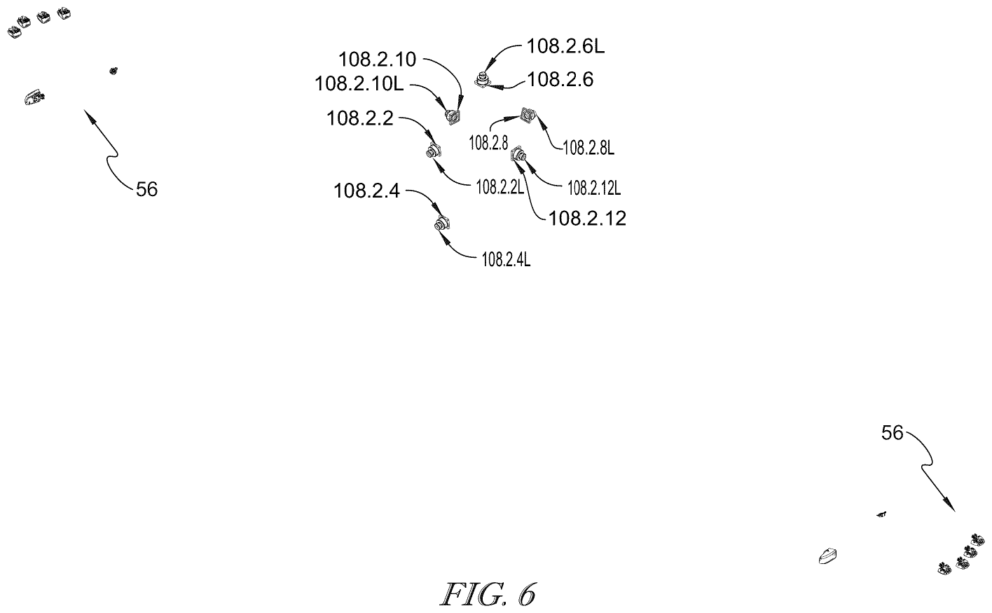

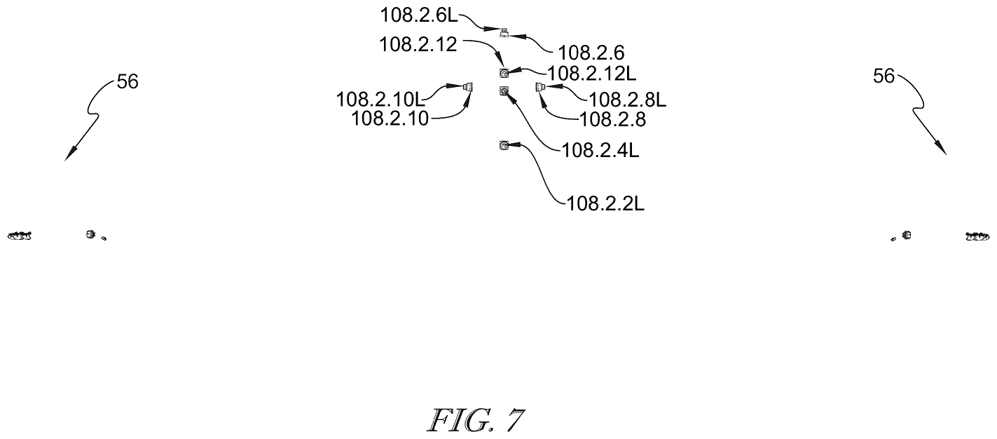

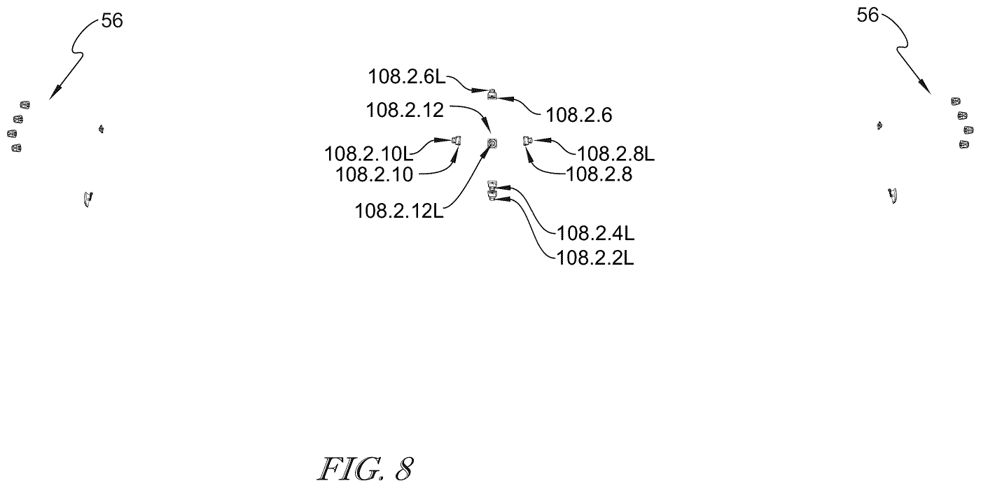

The front cover 102.2.2 is configured to cover a majority of the electronics assembly 108 that is coupled to the internal support frame 104 and is shaped with a curved surface to resemble a human as shown in FIGS. 5-7. The front cover 102.2.2 is configured to include openings for a screen 108.4 and at least one sensor (e.g., upper camera 108.2.2, lower camera 108.2.4, top camera 108.2.6) of the electronics assembly 108 mounted on the internal support frame 104. The sensor openings 102.2.2.4.2, 102.2.2.4.4, 102.2.2.4.6 in the front cover 102.2.2 are vertically aligned in the sagittal plane of the robot (and the head) when the robot (or head) is in a natural or original upright position as shown in FIGS. 5-7. In particular, the upper, lower, and top sensor openings 102.2.2.4.2, 102.2.2.4.4, 102.2.2.4.6 are horizontally centered in the head, but are not vertically centered in the head. Instead, said upper and lower sensor openings 102.2.2.4.2, 102.2.2.4.4, are vertically positioned lower than the center of the head or moved towards the chin portion of said head, while said top opening 102.2.2.4.6 is at the top of the head.

ii. Rear Cover Assembly

The rear cover 102.2.4 covers or overlies a rear portion of the electronics assembly 108 coupled to the internal support frame 104 as shown in FIGS. 5-7. The rear cover 102.2.4 is configured to include an opening 102.2.4.2 for at least one sensor (e.g., rear camera 108.2.8) of the electronics assembly 108 mounted on the internal support frame. The sensor opening 102.2.4.2 in the rear cover 102.2.4 is also vertically aligned in the sagittal plane of the robot (and the head) when the robot (or head) is in a natural or original upright position as shown in FIGS. 5-7. In particular, the upper sensor opening 102.2.2.4.2, the lower sensor opening 102.2.2.4.4, the top sensor opening 102.2.2.4.6, and the rear sensor opening 102.2.4.2 are horizontally centered in the head.

iii. Front Shield

The frontal shield 102.4 is configured to cover or overlay the front cover 102.2.2 and the rear cover 102.2.4 or portions of the front cover 102.2.2 and the rear cover 102.2.4. The frontal shield 102.4 may be made from a transparent material so that the screen 108.4 mounted in the front cover 102.2.2 may be viewed therethrough. The frontal shield 102.4 may have a different curvature than the screen 108.4. As shown in FIGS. 5-7, the frontal shield 102.4 may include a curved surface and be configured to cover the front cover 102.2.2 and couple to the rear cover 102.2.4 at the rim 102.2.2.6.4. The frontal shield 102.4 is shaped to resemble the form of the head 10, providing a substantially continuous surface between the sections of the enclosure 102.2. The curvature of the frontal shield 102.4 may vary and have different curvatures (i.e., radii and arcs) at different positions along the frontal shield 102.4.

Although the illustrative embodiment shows the frontal shield 102.4 is sized to match or substantially match the enclosure 102.2, the frontal shield 102.4 may occupy any portion or ratio of the robot's head and may have any configuration. The frontal shield may: (i) wrap from the front of the head into the side regions of the head, (ii) extend into the chin area or cover the entire chin area, and (iii) may have a non-uniform rear edge. The plurality of recesses may be configured to receive an extent of a light or indicator. The disclosed frontal shield may occupy between 25% and 95% of the head and may be curved in two directions (e.g., vertically and horizontally). In some embodiments, the frontal shield 102.4 and the screen 108.4 may be integrated into a single component or may be formed from a plurality of components.

The frontal shield 102.4 includes sensor apertures 102.4.4 configured to align with the sensor openings 102.2.2.4.2, 102.2.2.4.4, 102.2.2.4.6 formed in the front cover 102.2.2. The formation of the combination of the sensor apertures 102.4.4 and sensor openings 102.2.2.4.2, 102.2.2.4.4, 102.2.2.4.6 enables the lenses of the upper camera 108.2.2, the lower camera 108.2.4, and the top camera 108.2.6 to be unobstructed. This reduces potential distortion of the images captured by the cameras 108.2.2, 108.2.4, 108.2.6, which reduces processing, battery usage, and generation of heat.

iv. Gorget Interface and Neck Shell

The neck shell 102.8 is designed to extend from an upper portion of the torso 16 to a lower portion of the head 10. In particular, shown in FIGS. 5-7, the neck shell 102.8 is configured to wrap around at least an edge portion of the head enclosure 102.2 and at least an edge portion of the gorget interface 102.6. In doing so, said neck shell 102.8 obscures the actuators J8.1, J8.2 and other electronics contained therein. The neck shell 102.8 may be made from a material (e.g., fabric or deformable plastic) that allows the head to twist in both directions and pitch forward and back without bunching or pulling. It is designed to return to its original state when the head returns to its normal state.

As shown in FIGS. 5-7, the neck shell 102.8 has a rear extension 102.8.2 that extends up along a rear of the head and is configured to cover or overlay the rear cover 102.2.4 or portions of the rear cover 102.2.4. The rear extension 102.8.2 is shaped to resemble the rear or back of the head 10. The curvature of the rear extension 102.8.2 of the neck shell 102.8 may vary and have different curvatures (i.e., radii and arcs) at different positions along the extension 102.8.2.

The rear extension 102.8.2 of the neck shell 102.8 includes a sensor aperture 102.8.2.2 configured to align with the sensor opening 102.2.4.2 formed in the rear cover 102.2.4. The formation of the combination of the sensor aperture 102.8.2.2 and sensor opening 102.2.4.2 enables the lens of the rear camera 108.2.8 to be unobstructed. Just like for the upper, lower, and top cameras 108.2.2, 108.2.4, 108.2.6, this reduces potential distortion of the images captured by the rear camera 108.2.8, which reduces processing, battery usage, and generation of heat.

b. Electronics Assembly

The electronics assembly 108 contained in the head 10 may include: (i) a sensor assembly 108.2, (ii) a screen 108.4, (iii) a directional microphone, (iv) one or more speakers, (v) antennas, (vi) indicator lights 108.12, (vii) a data storage device, and (viii) other electronics (e.g., IMU, RFID reader, location sensors (e.g., Global Positioning System (“GPS”), GLONASS, Galileo, QZSS, and/or iBeacon), etc.), and/or PCBs for connecting said electronics. The data storage device may be a removable memory device or integrated in a computing device comprising a processor and a memory. In some examples, the data storage device may be housed in another portion of the robot 1, such as the torso 16. In some examples, the data storage device may be configured to store data collected from other components of the robot 1. The components of the electronics assembly 108 may be mounted to the internal support frame 104 configured to position the individual items of the sensor assembly 108.2 in the desired positions. As noted above, the housing 102 is configured to enclose the electronics assembly 108 without interfering with the transmission or reception of signals. For example, the housing 102 does not obscure the line of sight of the sensors.

i. Sensor Assembly

The sensor assembly 108.2 may include one or more cameras, temperature sensors, pressure sensors, force sensors, inductive sensors, capacitive sensors, ultrasonic sensors, infrared sensors, proximity sensors, microphones, gas sensors, light sensors (photodiodes, phototransistors), UV sensors, time-of-flight sensors, LiDAR sensors, optical flow sensors, RFID readers, laser rangefinders, 3D depth cameras, or any combination of these sensors or other known sensors. Each camera may include an imaging detector and a lens that overlies the imaging detector. In the illustrative example, the sensor assembly 108.2 includes an upper camera 108.2.2, a lower camera 108.2.4, a top camera 108.2.6, and a rear camera 108.2.8 coupled to the internal support frame 104 at respective mounting positions. For example, upper camera 108.2.2 may be positioned above the screen 108.4 and the lower camera 108.2.4 may be positioned below the screen 108.4, both directed in a substantially forward direction. The top camera 108.2.6 may be positioned at or near the top of the head 10 facing in a substantially upward direction. The rear camera 108.2.8 may be positioned on the rear of the head 10 facing in a substantially rearward direction opposite the forward direction. In some embodiments, an imaging detector within one of the head cameras, such as a second imaging detector, may be identical to a first imaging detector located in a vision sensor of an end effector.

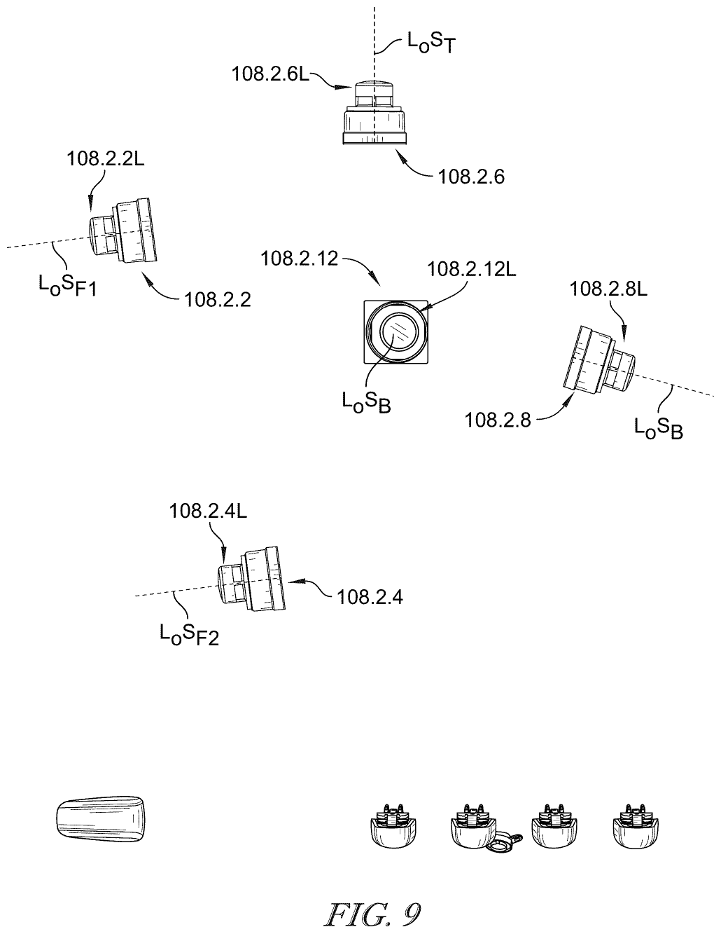

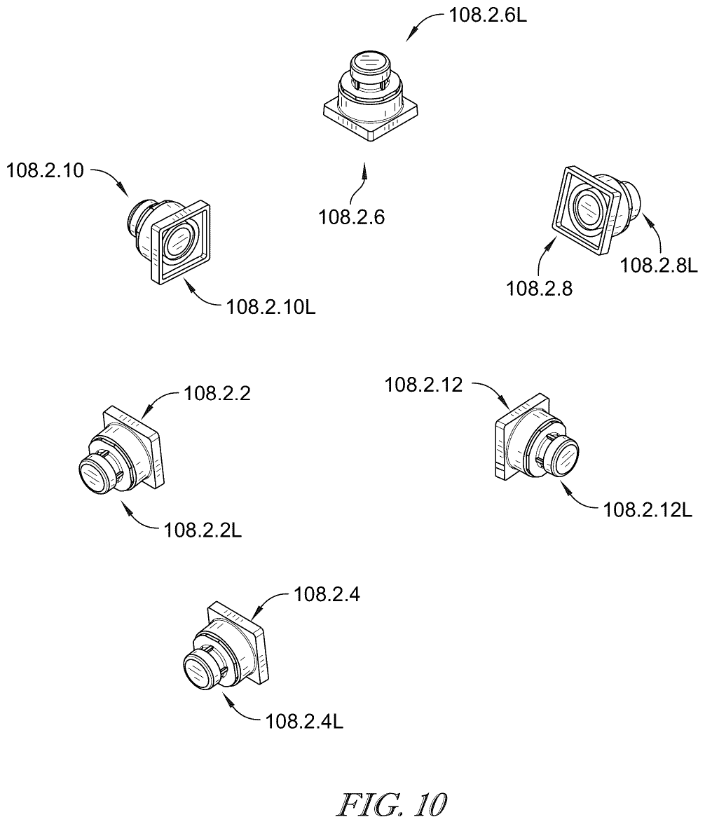

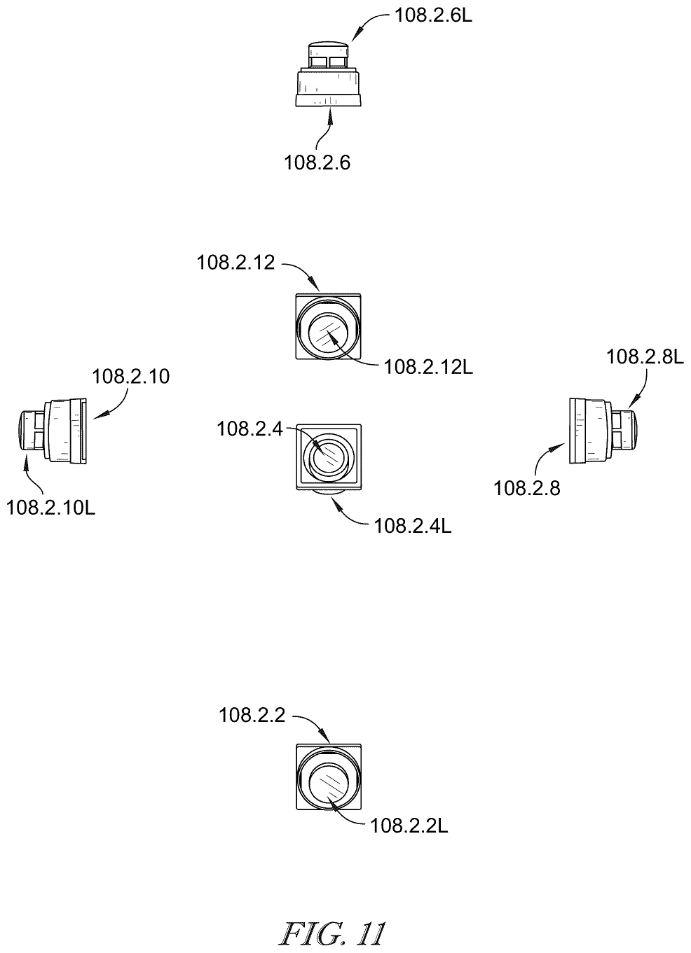

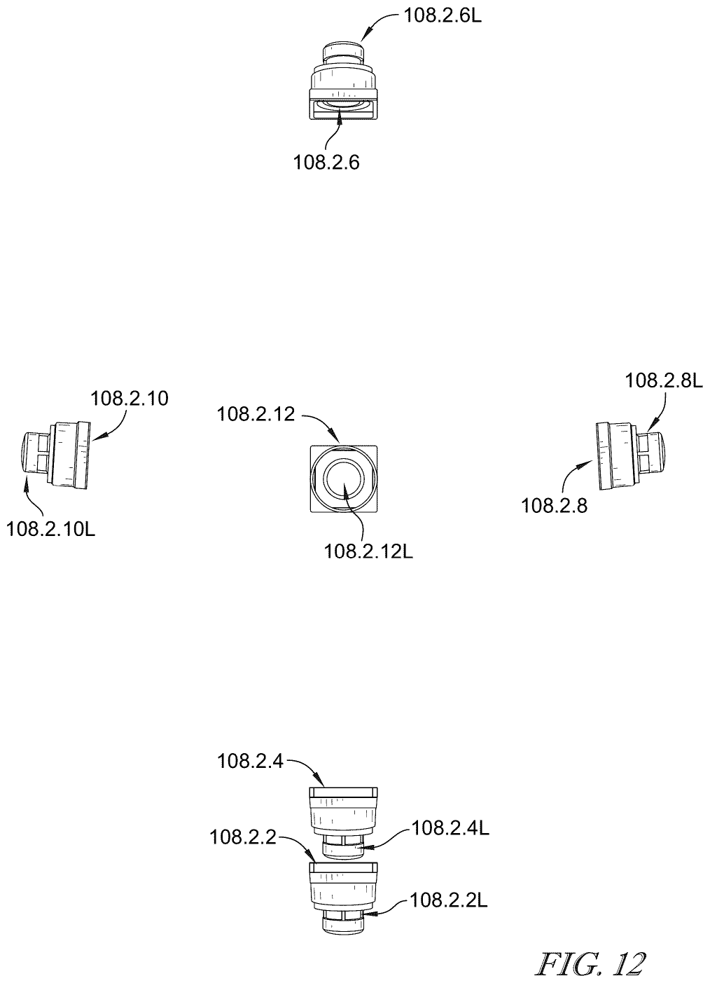

As shown in FIGS. 9-11, the upper camera 108.2.2, the lower camera 108.2.4, and the rear camera 108.2.8 may be arranged in a vertical orientation. The upper, lower, and rear cameras 108.2.2, 108.2.4, 108.2.8 may be placed at the same angle relative to the horizontal plane or transverse plane in some embodiments. In other embodiments, the upper, lower, and rear cameras 108.2.2, 108.2.4, 108.2.8 may be placed at different angles relative to the horizontal plane or transverse plane. For example, the upper and lower cameras 108.2.2, 108.2.4 may be positioned at a slight downward angle of about 6.0 to about 9.0 degrees, or about 6.7 to about 8.2 degrees with respect to the horizontal plane or transverse plane. the rear camera 108.2.8 may be positioned at a downward angle of about 14 to about 22 degrees, or about 14.4 to about 21.6 degrees with respect to the horizontal plane or transverse plane. The top camera 108.2.6 may be arranged in the horizontal plane or transverse plane as shown in FIGS. 9-11. The lenses of each of the upper, lower, and top cameras 108.2.2, 108.2.4, 108.2.6 can be received within the respective sensor openings 102.2.2.4.2, 102.2.2.4.4, 102.2.2.4.6 of the front cover 102.2.2. The lens of the rear camera 108.2.8 can be received within the respective sensor opening 102.2.4.2 of the rear cover 102.2.4.

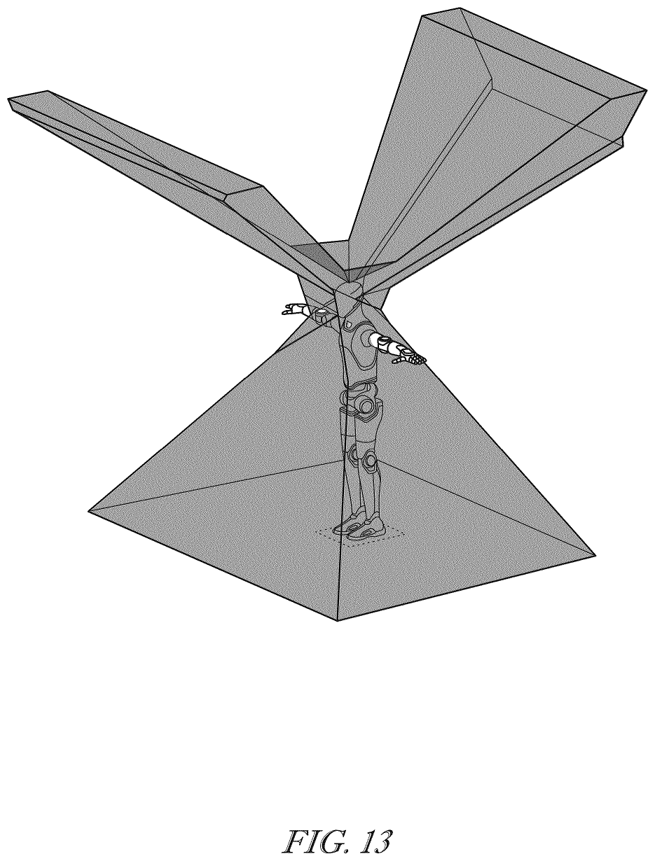

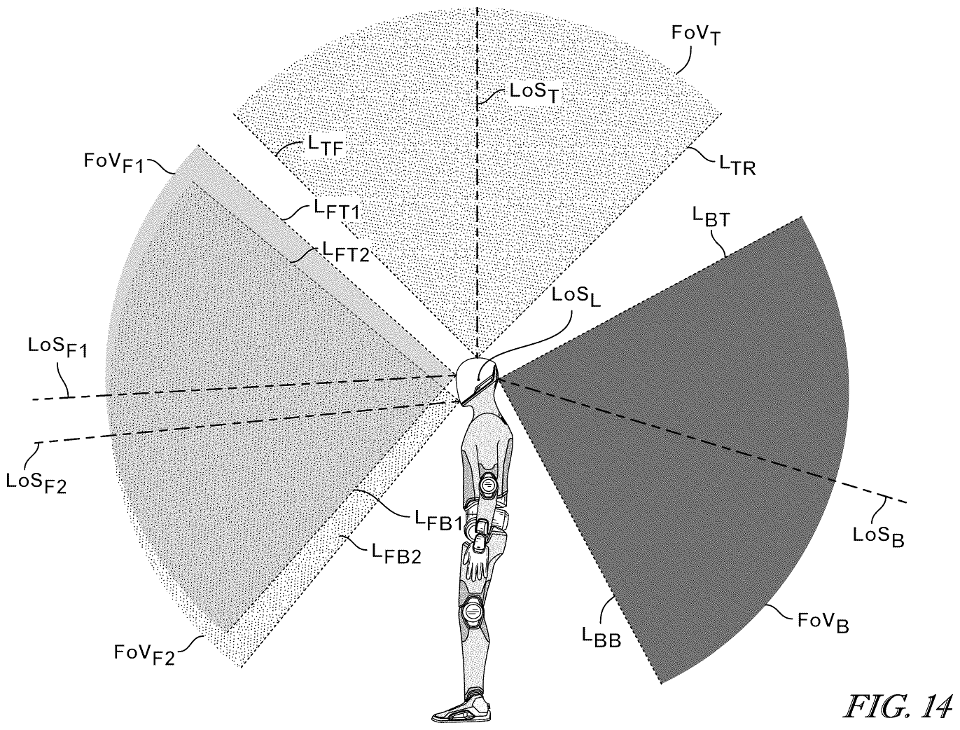

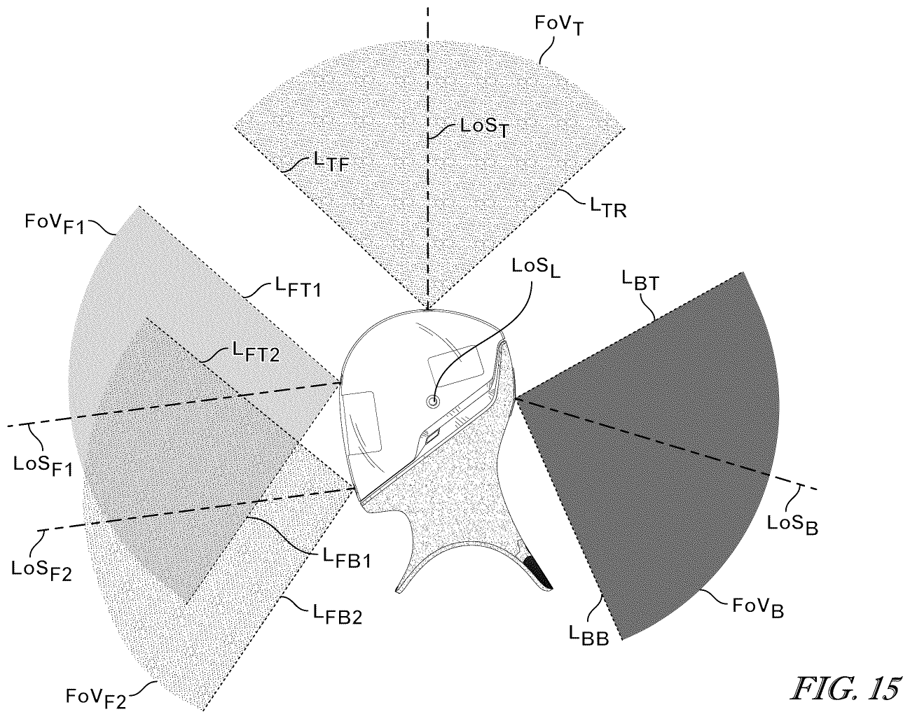

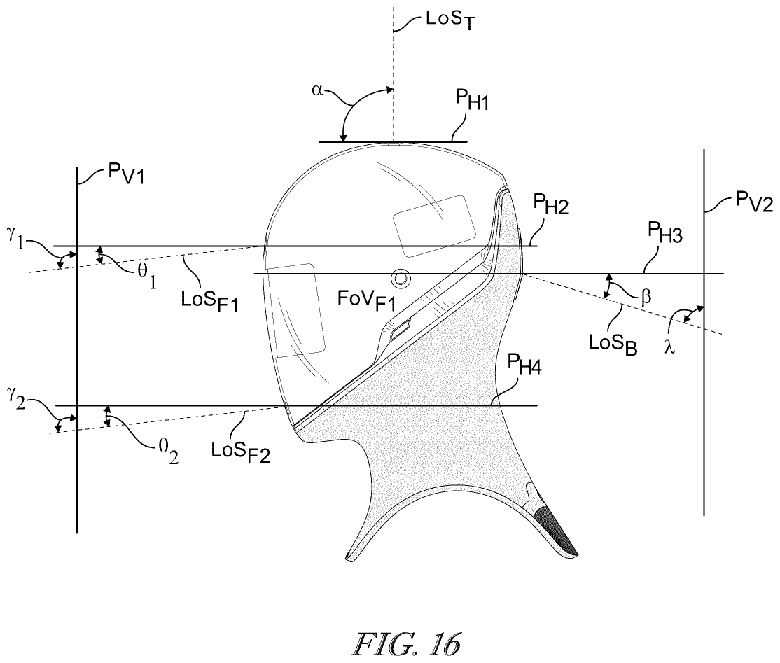

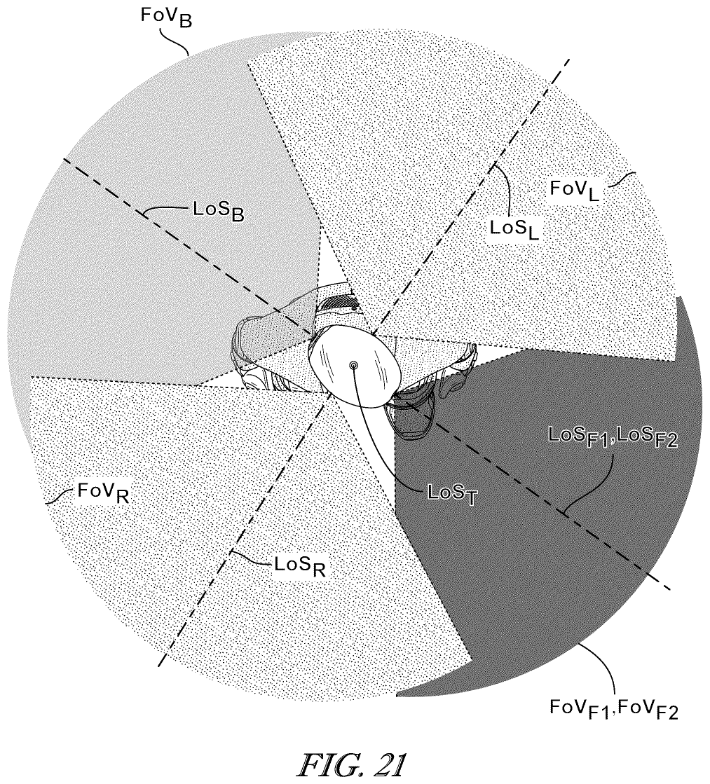

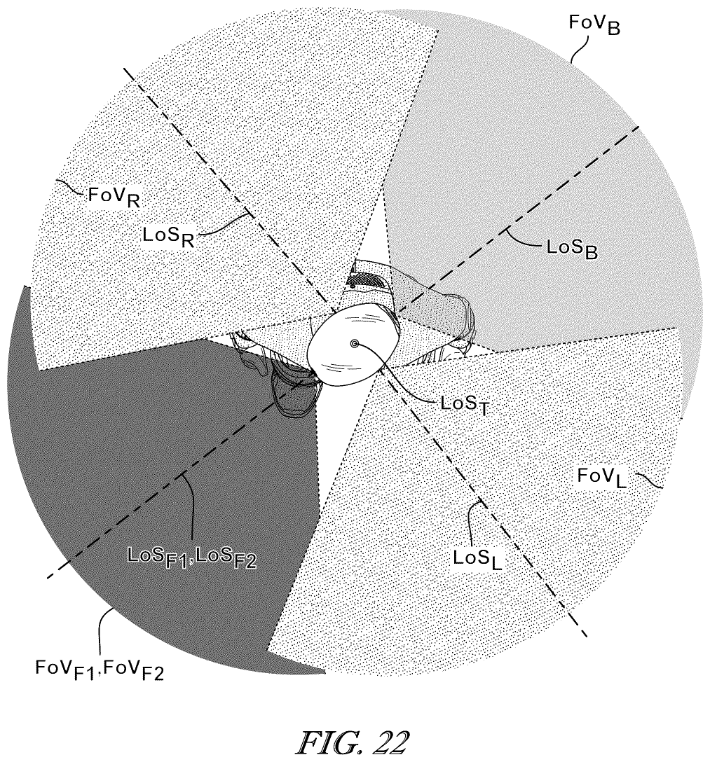

The upper and lower cameras 108.2.2, 108.2.4 are primarily for tasks, providing a field of view in front of the robot, while the rear camera 108.2.8 is primarily for situational awareness and localization of the robot 1, providing a field of view behind the robot. The top camera 108.2.6 also assists with localization of the robot 1. The cameras 108.2.2, 108.2.4, 108.2.6, 108.2.8 are not 360-degree cameras and have restricted fields of view as shown in FIGS. 13-19 and 20-22. Examples of the fields of view of the upper camera 108.2.2, the lower camera 108.2.4, the top camera 108.2.6, and the rear camera 108.2.8 are shown in FIGS. 13-19 and 20-22. The positions of the cameras 108.2.2, 108.2.4, 108.2.6, 108.2.8 may be altered to provide a fuller field of view and minimize blind spots. For example, the angles of the upper camera 108.2.2, the lower camera 108.2.4, the top camera 108.2.6, and the rear camera 108.2.8 may be adjusted to provide the fuller field of view and minimize blind spots or dead space. Positioning the camera sensors 108.2.2, 108.2.4, 108.2.6, 108.2.8 on the robot's head 10 also allows for movement of the sensors 108.2.2, 108.2.4, 108.2.6, 108.2.8 for better viewing with less movement of the overall robot 1. By moving the robot's head 10 up and down and rotating the head 10 left and right, the target image within the fields of view of the cameras 108.2.2, 108.2.4, 108.2.6, 108.2.8 is changed and provides a larger, derivative field of view from the sensor assembly 108.2.

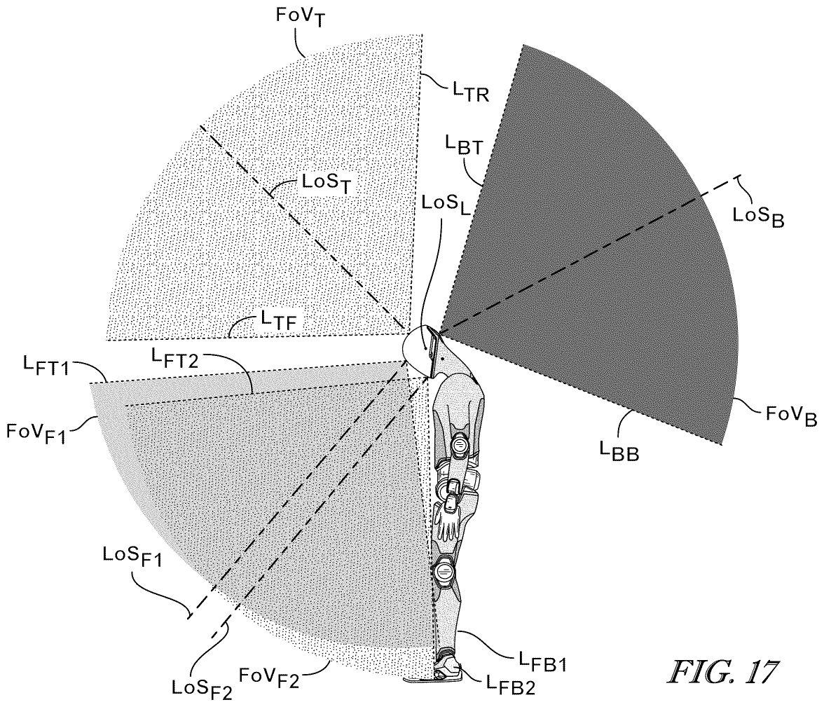

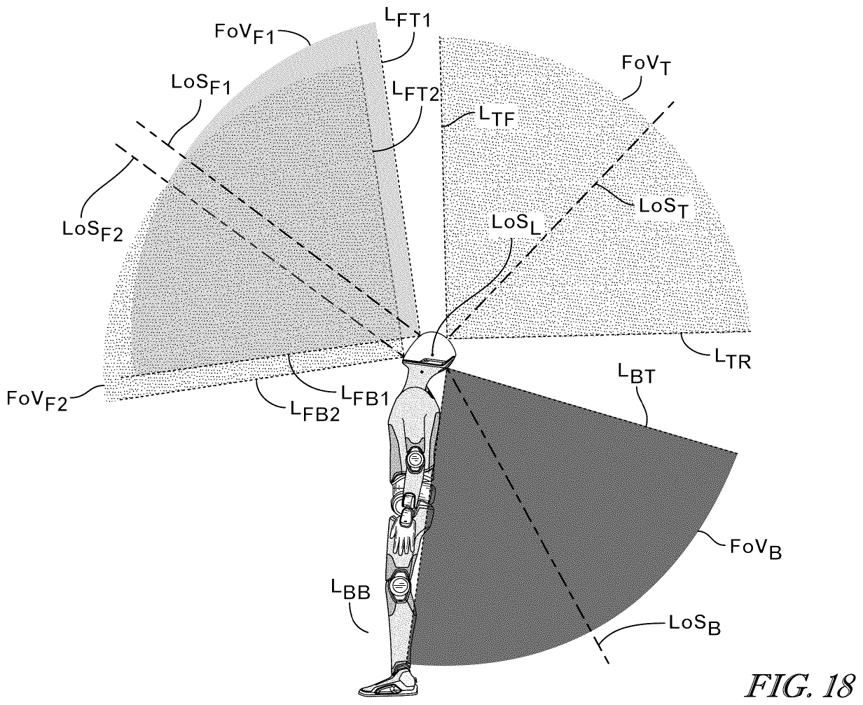

As shown in FIGS. 17-18, the robot 1 may move its head up and down by bending at the neck to adjust the orientation of the cameras 108.2.2, 108.2.4, 108.2.6, 108.2.8. For example, the neck is able to bend up and down about ±25 degrees, which allows the upper and lower cameras 108.2.2, 108.2.4 to view 200 mm in front of the robot's feet 92 and allows the rear camera 108.2.8 to view 400 mm behind the robot's feet 92 as shown in FIGS. 17 and 18. About 20 degrees of torso lean in the forward direction allows the upper and lower cameras 108.2.2, 108.2.4 to view the feet 92. The positions of the cameras 108.2.2, 108.2.4, 108.2.8 thus provide a closer or better view to the robot's feet 92 compared to cameras mounted to the torso 16 of the robot 1 because the fields of view of the upper and lower cameras 108.2.2, 108.2.4 are not entirely blocked by the robot's legs 6.

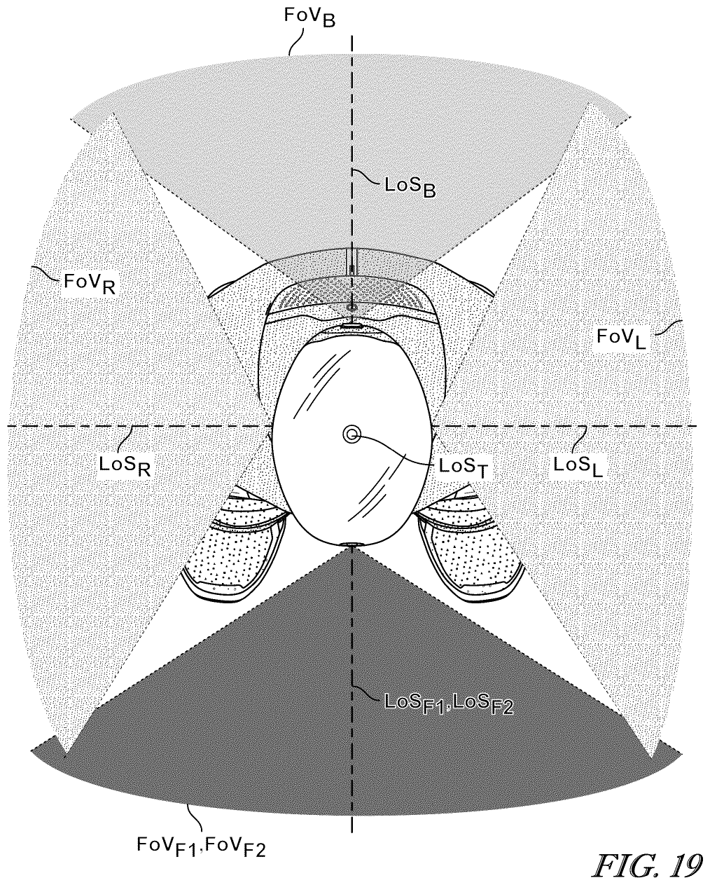

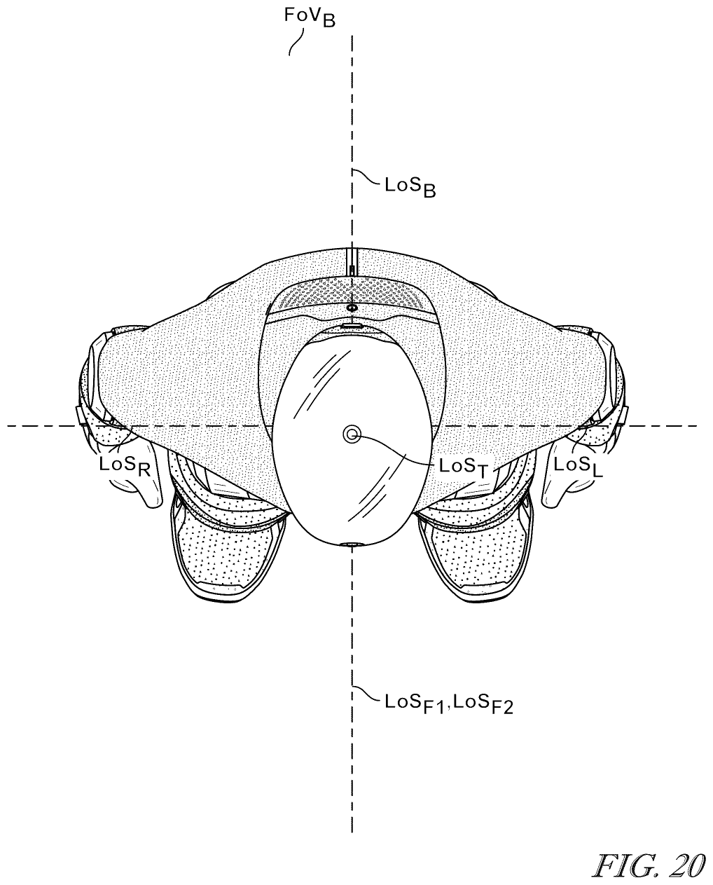

As shown in FIGS. 20-22, the robot 1 may turn its head 10 left and right to adjust the orientation of the cameras 108.2.2, 108.2.4, 108.2.8. However, rotating the head 10 from left to right does not adjust the orientation of the top camera 108.2.6. The images or video recorded by the cameras 108.2.2, 108.2.4, 108.2.6, 108.2.8 may be combined or stitched together to produce a larger overall field of view from the sensor assembly 108.2.

Although upper, lower, top, and rear cameras 108.2.2, 108.2.4, 108.2.6, 108.2.8 are shown as illustrative examples, other sensors may be relied on and coupled to the internal support frame 104 in a similar manner to ensure proper directional positioning for respective detection, sensing, or signal reception. Said sensors may include: (i) scan camera(s), (ii) monochrome camera(s), (iii) color camera(s), (iv) CMOS camera(s), (v) CCD sensor(s) or camera(s) that include CCD sensor(s), (vi) camera(s) or sensor(s) that have a rolling shutter or global shutter, (vii) other types of 2D digital camera(s), (viii) other types of 3D digital camera(s), (ix) camera(s) or sensor(s) that are capable of stereo vision, structured light, and laser triangulation, (x) sonar camera(s) or ultrasonic camera(s), (xi) infrared sensor(s) and/or infrared camera(s), (xii) radar sensor(s), (xiii) LiDAR, (xiv) other structured light sensors, camera(s), or technologies, (xv) dot projecting camera(s) or sensor(s), (xvi) Time-of-Flight (ToF) cameras, (xvii) hyperspectral cameras, (xviii) multispectral cameras, (xix) thermal imaging cameras, (xx) high-speed cameras, (xxi) panoramic cameras, (xxii) omnidirectional cameras, (xxiii) polarization cameras, (xxiv) plenoptic (light field) cameras, (xxv) depth-sensing cameras, (xxvi) ultraviolet (UV) cameras, (xxvii) single-photon avalanche diode (SPAD) cameras, (xxviii) electron-multiplying CCD (EMCCD) cameras, (xxix) short-wave infrared (SWIR) cameras, (xxx) medium-wave infrared (MWIR) cameras, (xxxi) long-wave infrared (LWIR) cameras, (xxxii) quantum dot cameras, (xxxiii) microbolometer cameras, (xxxiv) holographic cameras, (xxxv) optical coherence tomography (OCT) cameras, (xxxvi) spectral imaging cameras, (xxxvii) phase contrast cameras, (xxxviii) interferometric cameras, (xxxix) fiber optic cameras, (xl) terahertz cameras, (xli) millimeter-wave cameras, (xlii) acoustic cameras, (xliii) biometric cameras (e.g., iris recognition cameras), (xliv) artificial compound eye cameras, (xlv) volumetric capture cameras, (xlvi) computational photography cameras, (xlvii) smartphone cameras with advanced sensors, (xlviii) augmented reality (AR) and virtual reality (VR) cameras, (xlix) streak cameras, (l) burst-mode cameras, (li) LiFi (Light Fidelity) cameras, or any combination of the above or any other known camera or sensor. For example, said camera may have a megapixel resolution of between 0.4 MP to 20 MP, may record video at 5.6 FPS to 286 FPS, may have a CMOS sensor, pixel size may range from 2.4 μm to 6.9 μm, may utilize a starvis rolling shutter technology, can operate in 55 degree c. ambient air temperatures, and may have any other properties, technologies, or features that are discussed within U.S. Pat. Nos. 11,402,726, 11,599,009, 11,333,954, or 11,600,010, all of which are incorporated herein by reference. It should be understood that the cameras are typically configured as video cameras but may have an alternative configuration, such as an image camera.

The information from each of the upper, lower, top, and rear cameras 108.2.2, 108.2.4, 108.2.6, 108.2.8 may be used alone or in combination with the information from the other cameras 108.2.2, 108.2.4, 108.2.6, 108.2.8 and/or sensors included on the robot 1 to aid in the control of the robot 1. The information from the upper, lower, top, and rear cameras 108.2.2, 108.2.4, 108.2.6, 108.2.8 may be used to help the robot 1 navigate or locomote on different terrain, localize to different environments and plan routes, and sense and avoid obstacles. The upper, lower, top, and rear cameras 108.2.2, 108.2.4, 108.2.6, 108.2.8 may be utilized in similar ways or methods that are discussed within U.S. Patent Application Publication 2005/0267631 and U.S. Pat. Nos. 10,638,906, 10,437,251, 11,020,860, 10,580,208, 11,485,013, 11,759,075, or 10,614,588, all of which are incorporated herein by reference.

Other dimensions of said sensor assembly 108.2 are described in the figures and in the below tables. It should also be understood that additional embodiments or alterations to said sensor assembly 108.2 will be discussed below and said embodiments may be partially or fully combined with any of the above described embodiments.

ii. Screen

The screen 108.4 of the electronics assembly 108 may be mounted to the internal support frame 104 and positioned such that a screen opening of the front cover 102.2.2 surrounds the screen 108.4. The screen 108.4 is operatively connected to at least one processor and is designed to display status messages and other information. For example, the screen 108.4 may display information: (i) related to the robot's state (e.g., working, error, moving, etc.), (ii) obtained from sensors contained within the head assembly 10 or on other portions of the robot 1, or (iii) received from other processors in communication with the screen 108.4 (e.g., other internal processors housed within the robot or external information transmitted and received by the robot). Said information may be displayed in the format of blocks, well-known shapes, logos, or other moving items (e.g., thought bubbles). However, said information may not be displayed in connection with human facial features (e.g., eyes, mouth, nose).

In various embodiments, the screen 108.4 may be a plurality of screens and the front cover 102.2.2 may include additional screen openings. The screen 108.4 may have a substantially rectangular display surface that has a convex curvature that conforms with the curvature of front cover 102.2.2 of the housing 102. The screen 108.4 may be slightly tilted downward to increase viewability and help eliminate reflections. The screen may use any known technology or feature including, but not limited to: LCD, LED, OLED, LPD, IMOD, QDLED, mLED, AMOLED, SED, FED, plasma, electronic paper or EPD, MicroLED, quantum dot display, LED backlit LEC, WLCD, OLCD, transparent OLED, PMOLED, capacitive touchscreen, resistive touchscreen, monochrome, color, or any combination of the above, or any other known technology or screen feature.

It should be understood that this application contemplates the use of screens that have different sizes. Alternative screen sizes may be used to: (i) reduce the surface area of fragile elements within the robot, (ii) because said robot is not designed to work near humans, (iii) additional area within the head is needed for sensors or other electronics, or (iv) any other reason known by one of skill in the art. The disclosed screen may occupy the entire frontal shield 102.4, between 100% and 75% of the frontal shield, between 75% and 50% of the frontal shield, between 50% and 25% of the frontal shield, or less than 25% of the frontal shield. In some examples, the screen may utilize the full frontal shield 102.4. The screen may be curved in a single direction, in two directions (e.g., vertically and horizontally), or a freeform design that may include multiple curves. In certain embodiments, the frontal shield 102.4 and the screen 108.4 may be integrated into a single unit. The size and shape of the screen 108.4 may adjust the position of the upper and lower cameras 108.2.2, 108.2.4 depending on the available space.

iii. Other Electronic Components

As described above, the electronic components of the head may also include a directional microphone, speaker, antennas, indicator lights 108.12, as well as a data storage device and/or computing device comprising a processor and memory. Specifically, the directional microphone may be designed to detect sounds and determine a position, which enables the robot to move its head toward the sound. In particular, one or more speakers may be configured to allow the robot to communicate with nearby humans with audible messages or responses. One or more antennas may be configured to transmit and receive data wirelessly for data transfer into and out of the robot. Specifically, said robot may include wireless communication modules (e.g., cellular, Wi-Fi, Bluetooth, WiMAX, HomeRF, Z-Wave, Zigbee, THREAD, RFID, NFC, and/or etc.) that are connected to said antennas.

The data storage device may include a solid-state hard drive designed to capture all of the data generated by the sensors or a subset of the data generated by the sensors. Said subset of the data may be time-based (e.g., the pre-defined time surrounding the start up/shut down of the robot), sensor-based (e.g., only encoder data), movement/configuration-based (e.g., when performing a specific task that requires the robot to put its body in a particular position/configuration), environment-based (e.g., when the robot recognizes a specific item or issue in its environment), or configuration based, error based, or a combination thereof. In addition, the data storage device may be used to store data to train other robots or store data for diagnostic purposes or any other purpose. Finally, the indicator lights 108.12 may be designed to work with the screen 108.4 to indicate a state of the robot 1 (e.g., working, error, moving, etc.) to a nearby human or may illuminate for other reasons.

### 2. Torso

The torso assembly 16 is a central component within the humanoid robot 1, extending vertically between the pelvis 64 and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 contained primarily within the torso 16 includes various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

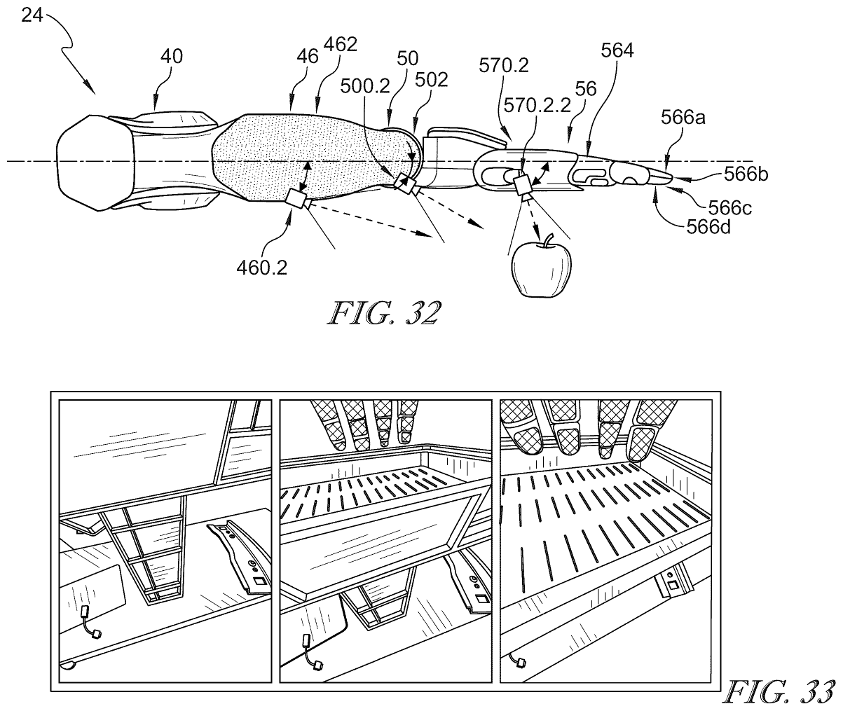

As shown in FIGS. 1 and 32, the arms 5 have an upper arm assembly 24 that extends from the torso 16 and a lower arm assembly that extends from the upper arm assembly. The lower arm assembly includes: (i) the upper forearm 40, (ii) the lower forearm 46, and (iii) wrist 50. The lower arm assembly includes three degrees of freedom, which include or can be referred to as pitch, roll, and yaw. Specifically, the upper forearm 40 lacks an actuator and instead acts as a transition point from the elbow actuator (J4) 374 to the lower forearm 46. The lower forearm 46 includes two actuators and the wrist 50 includes one actuator. These three actuators individually or in cooperation may change the position of the end effector 56 coupled to the wrist 50.

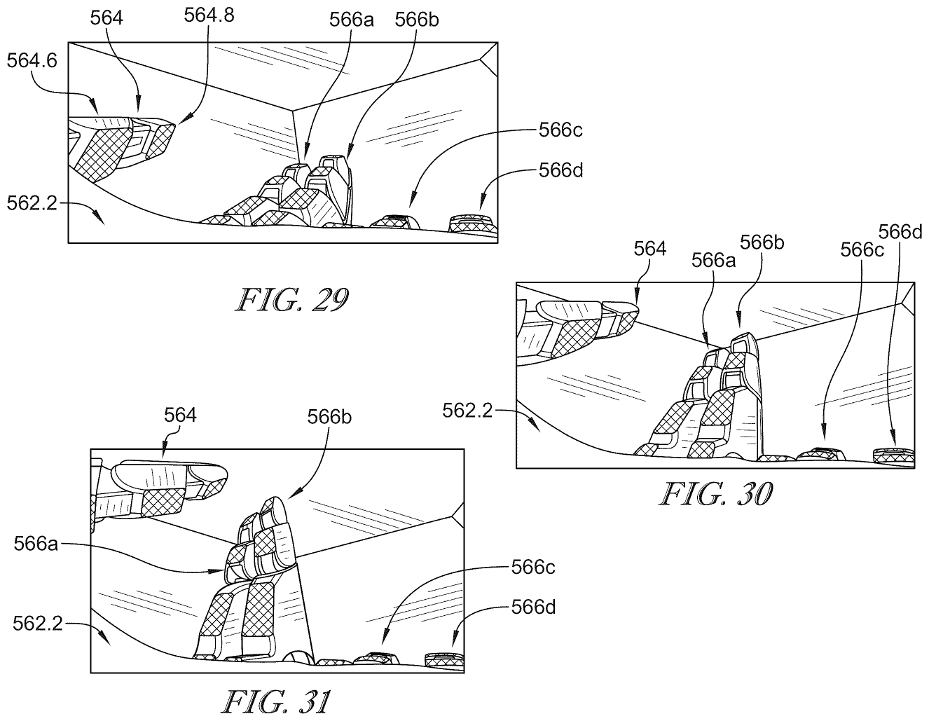

As shown in FIG. 32, the lower arm assembly may include cameras 460.2, 500.2 mounted to the respective housings 462, 502 of the lower forearm 46 and the wrist 50 at respective mounting positions. The forearm camera 460.2 is positioned on the lower forearm 46 of the arm 5 at an angle so that the forearm camera 460.2 is directed towards the end effector 56. The wrist camera 500.2 is positioned on the wrist 50 of the arm 5 at an angle so that the wrist camera 500.2 is directed toward the end effector 56. The forearm and wrist cameras 460.2, 500.2 aid the end effector camera 570.2 on the end effector 56 in providing a fuller field of view in front of the robot 1 for when the robot 1 is working to complete different tasks as suggested in FIGS. 29-31. The forearm camera 460.2 may be mounted to (i) the outside of the housing 462 of the lower forearm 46, (ii) the inside of the housing 462 of the lower forearm 46, or (iii) the frame of the lower forearm 46 housed within the housing 462. If the forearm camera 460.2 is mounted within the housing 462, the housing 462 of the lower forearm 46 may have sensor openings for the forearm camera 460.2. The lens of the forearm camera 460.2 may be received with the respective sensor opening to prevent the lens of the forearm camera 460.2 from being obstructed.

The wrist camera 500.2 may be mounted to the inside or outside of the housing 502 of the wrist 50. The housing 502 may have a cavity or space formed therein for the wrist camera 500.2. If the wrist camera 500.2 is mounted within the housing 502, the housing 502 may have sensor openings for the wrist camera 500.2. The lens of the wrist camera 500.2 may be received with the respective sensor opening to prevent the lens of the wrist camera 500.2 from being obstructed.

The forearm camera 460.2 and the wrist camera 500.2 are both arranged in the downward orientation, like the end effector camera 570.2, facing toward the end effector 56. The forearm camera 460.2 and the wrist camera 500.2 may be placed at the same angle relative to the horizontal plane or transverse plane in some embodiments. The forearm camera 460.2 and the wrist camera 500.2 may be placed at the same angle as the end effector camera 570.2 relative to the horizontal plane or transverse plane. In other embodiments, the forearm camera 460.2, the wrist camera 500.2, and the end effector camera 570.2 may each be placed at different angles relative to the horizontal plane or transverse plane.

Like the end effector camera 570.2, the forearm camera 460.2 and the wrist camera 500.2 are primarily for tasks, providing a field of view in front of the robot. The forearm camera 460.2 and the wrist camera 500.2 are not 360-degree cameras and have restricted fields of view as shown in FIGS. 29-31. Examples of the fields of view of the forearm camera 460.2, the wrist camera 500.2, and the end effector camera 570.2 are shown in FIGS. 29-31. The positions of the forearm camera 460.2 and the wrist camera 500.2 may be altered to provide a fuller field of view and minimize blind spots. For example, the angles of the forearm camera 460.2 and the wrist camera 500.2 may be adjusted to provide the fuller field of view and minimize blind spots or dead space. Positioning the forearm camera 460.2 and the wrist camera 500.2 on the robot's arm 5 also allows for movement of the sensors 460.2, 500.2 for better viewing with less movement of the overall robot 1. By articulating the arm 5 and the wrist 50, the target image within the fields of view of the cameras 460.2, 500.2 is changed and provides a larger, derivative field of view.

### 4. End Effector Assemblies

Each end effector 56 is coupled to the arm assembly 5 at a distal end of the arm assembly 5 and includes: (a) an end effector housing 562, (b) a thumb assembly 564, (c) at least one finger assembly 566, and (d) an electronics package 570 or control assembly that is configured to control said thumb assembly 564 and said at least one finger assembly 566 (e.g., finger assemblies 566a-566d). The housing assembly 562 is designed to: (i) encase and protect the electronics package 570 and (ii) secure the finger assemblies 566a-566d in at least one plane (e.g., Y-Z plane). The thumb assembly 564 and finger assemblies 566a-566d are coupled to a frame of the housing 562 to move relative to the housing 562 between an open, uncurled, or neutral state, a partially curled state, and a fully curled state.

a. End Effector Housing

The end effector housing assembly 562 may have: (i) a palm 562.2 or palmer side, (ii) a back 562.4 or dorsal side, (iii) left and right sides 562.6, 562.8, and (iv) a front 562.10. Said housing assembly 562 may be made from silicon, plastic (e.g., may include a known polymer composition), carbon composite, metal, a combination of these materials, and/or any other known material used in robot systems. In some embodiments, the exterior or skin of the end effector 56 may be less rigid or softer than the internal components of the housing assembly 562. For example, the exterior or skin of the end effector 56 may be made from a deformable silicon material, which may function as an energy attenuation member, while the internal frame of the housing assembly may be made from metal. It should be understood that these are examples of possible configurations and are not intended to be limiting in any manner.

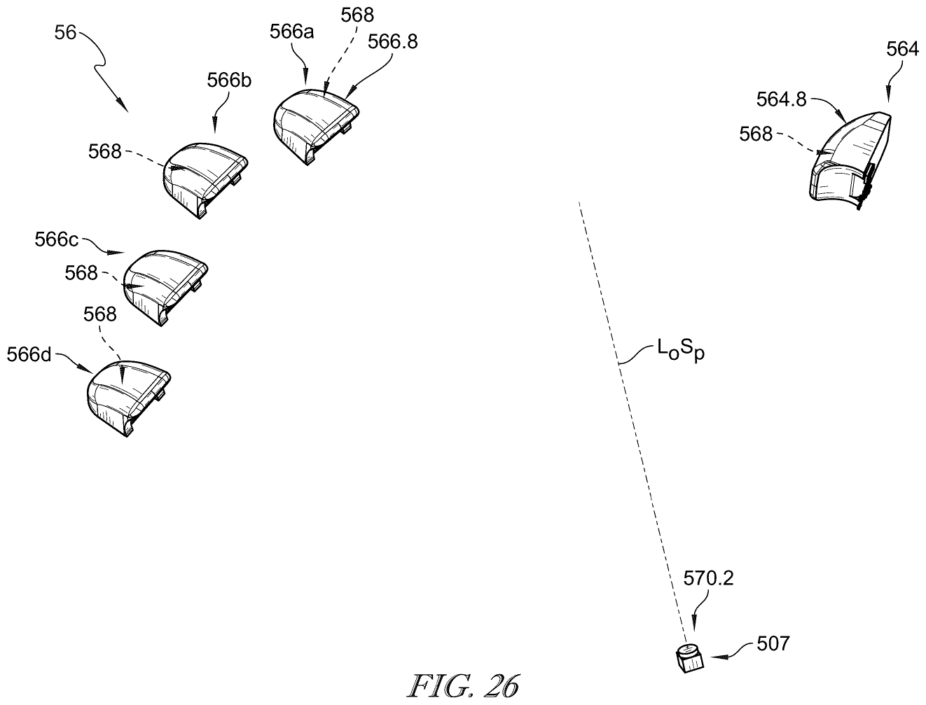

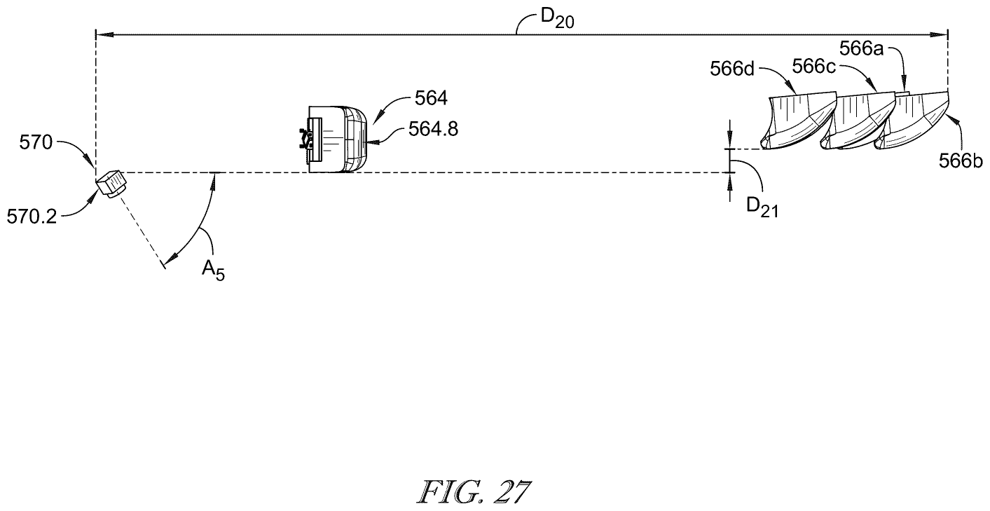

The end effector housing 562 is configured to include openings for at least one sensor (e.g., a vision sensor such as end effector camera 570.2) of the electronics package 570. As shown in FIGS. 26 and 27, the sensor opening 562.2.2 is on the palm 562.2 of the end effector housing 562 near the wrist 50. In other embodiments, the sensor opening 562.2.2 may be located on another area of the end effector housing 562. Alternatively, the sensors may be mounted to the exterior of the end effector housing 562.

b. Thumb and Finger Assemblies

As shown in FIG. 26, the thumb assembly 564 and each of the finger assemblies 566a-566d contained in the end effector 56 includes (i) a motor assembly, (ii) a knuckle assembly 564.2, 566.2, (iii) a proximal assembly 564.4, 566.4, (iv) a medial assembly 564.6, 566.6, and (v) a distal assembly 564.8, 566.8. A portion of the finger assembly 566 or thumb assembly 564 may have a first or second energy attenuation member affixed thereto, which may be made of a deformable material like silicon. The motor assembly may be a slotless BLDC motor, a brushed DC motor, an AC induction motor, or any other known motor that drives movement of the finger assembly 566a-566d between an open, uncurled, or neutral state, a partially curled state, and a fully curled state. The knuckle assembly 564.2, 566.2 is positioned forward of a majority of the motor assembly and is configured to allow the thumb assembly 564 or the finger assembly 566a-566d to move from the open, uncurled, or neutral state to the fully curled state. The proximal assembly 564.4, 566.4 is positioned between the knuckle assembly 564.2, 566.2 and the medial assembly 564.6, 566.6 and is the first portion of the thumb assembly 564 or the finger assembly 566a-566d configured to move relative to a palm surface 562.2 of the end effector housing 562. The medial assembly 564.6, 566.6 is positioned between the proximal assembly 564.4, 566.4 and the distal assembly 564.8, 566.8 and is the second portion of the thumb assembly 564 or the finger assembly 566a-566d configured to move relative to the palm 562.2. The distal assembly 564.8, 566.8 is positioned forward of the medial assembly 564.6, 566.6 and is the third portion of the thumb assembly 564 or the finger assembly 566a-566d configured to move relative to the palm 562.2.

c. End Effector Sensor Assembly

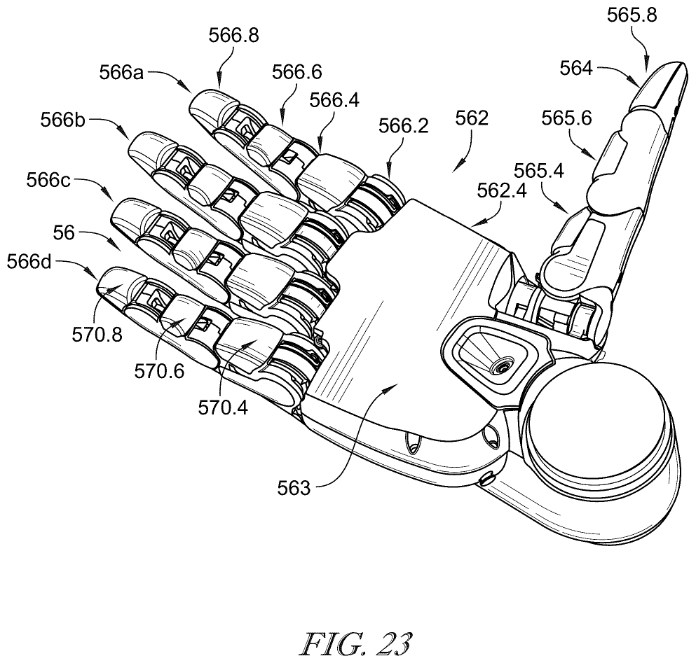

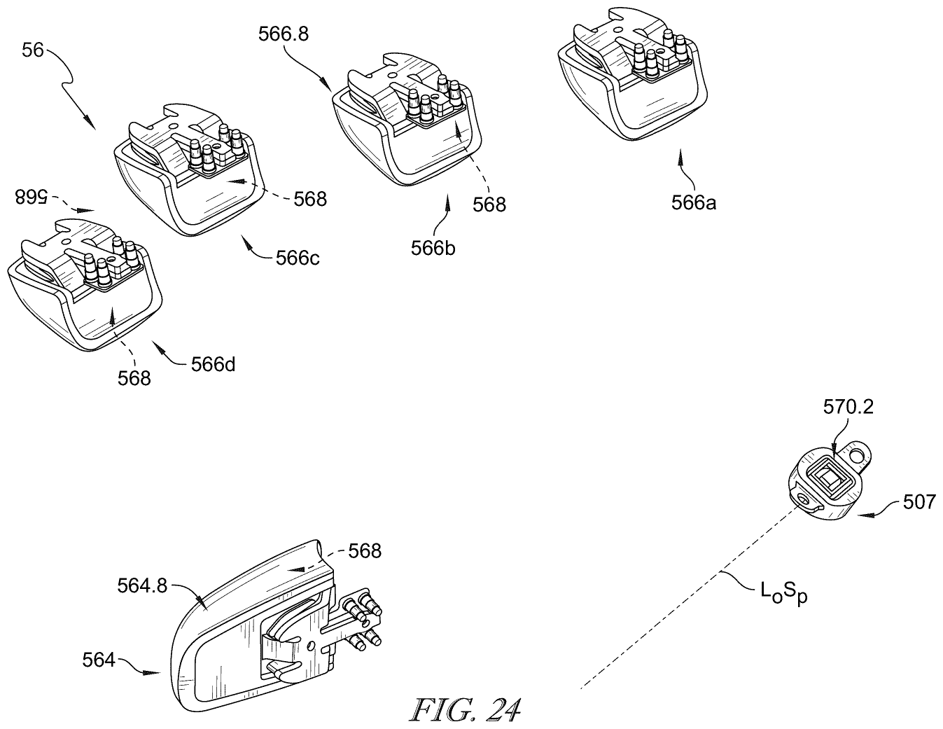

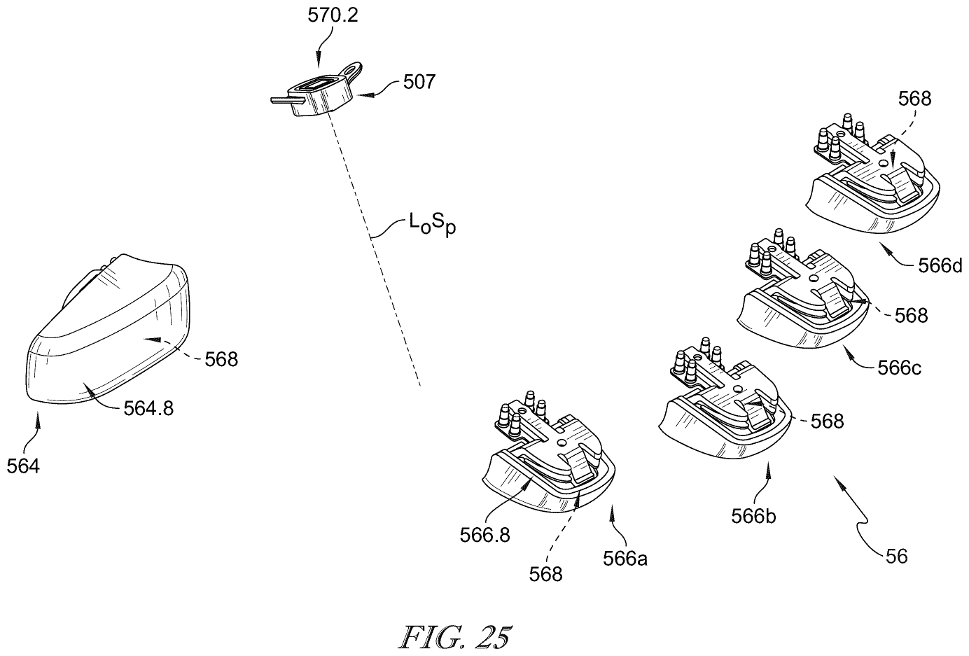

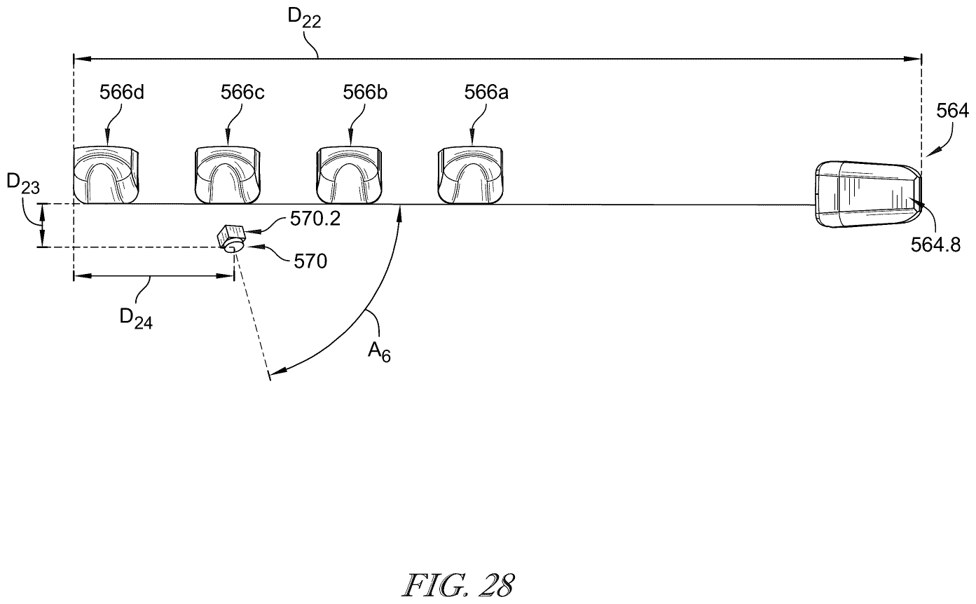

The electronics package 570 contained in the end effector 56 may include: (i) an end effector sensor assembly 570, (ii) tactile finger sensor assemblies 568, and (iii) other electronics for controlling the end effector 56. As shown in FIGS. 23-28, the end effector sensor assembly 570 is housed in the palm 562.2 of the end effector housing 562 and the finger sensor assemblies 568 are housed in the thumb and finger assemblies 564, 566a-566d.

i. End effector Sensor Assembly

The end effector sensor assembly 570 may include a vision sensor 570.2, which in turn may include one or more cameras, and may also include temperature, pressure, force, inductive, capacitive, any combination of these sensors, or other known sensors. In the illustrative example, the end effector sensor assembly 570 includes a vision sensor configured as an end effector camera 570.2 coupled to an internal sensor mounting frame of the end effector 56. The vision sensor 570.2 may comprise a first imaging detector, a lens that overlies and protects the imaging detector, and an illumination source positioned near the imaging detector. The vision sensor 570.2 is positioned between a distal end of the arm assembly 5 and the first finger assembly 566a, for example, on the palm 562.2 near the wrist 50, and is directed toward the thumb and finger assemblies 564, 566a-566d. This positioning ensures that the thumb and finger assemblies 564, 566a-566d are in the field of view of the end effector camera 570.2, as shown in FIGS. 29-31. The field of view is configured to include a majority of the palmer side 562.2 of the end effector 56, as well as the respective operational space of the first finger assembly 566a and at least a majority of the respective operational space of the thumb assembly 564. This enables the vision sensor 570.2 to detect information about contact between an object and an extent of the thumb assembly 564 and/or an extent of the first finger assembly 566a. The illumination source is arranged to illuminate at least a majority of this field of view, including the spatial region between the imaging detector and a distal end of the first finger assembly 566a.

In some embodiments, the end effector sensor assembly 570 may include more than one end effector camera 570.2 on the end effector 56 at respective mounting positions to provide more views of the thumb and finger assemblies 564, 566a-566d. For example, the end effector sensor assembly 570 may include additional end effector cameras arranged on the (i) back 562.4, (ii) left and right sides 562.6, 562.8, and (iii) a front 562.10 of the end effector housing 562.

While the end effector sensor assembly 570 is primarily shown as embedded in the end effector housing 562 of the end effector 56, it should be understood that it: (i) may not be embedded in the end effector; instead, may be integrally formed therewith or directly secured to an outer extent of said end effector, (ii) may be formed in a layer or external covering (e.g., a detachably removable protective cover or glove) that is positioned on top of or over said end effector, and/or (iii) a combination of any one of the described options. An example of possible combinations includes: (i) a portion of the end effector sensor assembly positioned in the glove and a portion of the end effector sensor assembly embedded within the end effector, (ii) a portion of the end effector sensor assembly secured to the exterior of the housing of said end effector and a portion of the end effector sensor assembly embedded within the end effector, (iii) a portion of the end effector sensor assembly positioned in the glove, a portion of the end effector sensor assembly secured to the exterior of the housing of said end effector, and a portion of the end effector sensor assembly embedded within the end effector, (iv) a portion of the end effector sensor assembly positioned in the glove, a portion of the end effector sensor assembly integrally formed with the exterior of the housing of said end effector, and a portion of the end effector sensor assembly embedded within the end effector, and/or (v) any combination or hybrid thereof.

As shown in FIGS. 24-27, the end effector camera 570.2 is arranged in a downward orientation, facing toward the thumb and finger assemblies 564, 566a-566d. The end effector camera 570.2 is placed at an angle relative to the horizontal plane or transverse plane. For example, as determined while the humanoid robot is in an extended state, the vision sensor 570.2 may be positioned at a downward-facing angle of about 45 to about 70 degrees, or about 46.3 to about 69.5 degrees with respect to a horizontal plane (PH), wherein the horizontal plane is parallel to a transverse plane of the humanoid robot and extends through the vision sensor. The end effector camera 570.2 may also be placed at an angle relative to a vertical plane (e.g., sagittal or coronal plane). For example, as determined while the humanoid robot is in an extended state, the vision sensor 570.2 may be positioned at an angle of about 12 to about 19 degrees, or about 12.2 to about 18.4 degrees with respect to a vertical plane (PV2), wherein the vertical plane is parallel to a coronal plane of the humanoid robot and extends through the vision sensor.

The lens of the end effector camera 570.2 can be received within the respective sensor opening 562.2.2 in the end effector housing 562 to prevent the lens of the vision sensor from being obstructed. The end effector camera 570.2 is primarily for tasks, providing a field of view in front of the robot. The end effector camera 570.2 provides a closer view of the end effector 56 compared to that of the upper and lower cameras 108.2.2, 108.2.4 on the head 10 as shown in FIG. 33. FIG. 33 illustrates the view from the upper and lower cameras 108.2.2, 108.2.4 on the head 10 compared to the end effector camera 570.2. When the robot 1 moves its end effectors 56 in front to do a task, the end effectors 56 may create blind spots for the upper and lower cameras 108.2.2, 108.2.4. The end effector camera 570.2 provides a view of the blind spot created as shown in FIG. 33.

The position of the end effector camera 570.2 or end effector cameras may be altered to provide a fuller field of view and minimize blind spots. For example, the angles of the end effector camera 570.2 may be adjusted to provide the fuller field of view and minimize blind spots or dead space. Positioning the vision sensor 570.2 on the robot's end effector 56 also allows for movement of the sensor 570.2 for better viewing with less movement of the overall robot 1. By moving the robot's arm 5 or end effector 56, the target image within the field of view of the camera 570.2 is changed and provides a larger, derivative field of view.

Although the end effector camera 570.2 is shown as an illustrative example, other sensors may be relied on and coupled to the end effector 56 in a similar manner to ensure proper directional positioning for respective detection, sensing, or signal reception. Said sensors may include any sensor disclosed above or known in the art. The information from each of the end effector cameras 570.2 may be used alone or in combination with the information from the other cameras 108.2.2, 108.2.4, 108.2.6, 108.2.8 and/or sensors included on the robot 1 to aid in the control of the robot 1. For example, information about contact detected by the vision sensor 570.2 may be used, at least in part, to control movement of the first finger assembly 566a and movement of the thumb assembly 564. The information from the end effector cameras 570.2 may be used to help the robot 1 navigate or locomote on different terrain, localize to different environments, plan routes, and sense and avoid obstacles. The humanoid robot may also use information derived from the vision sensor 570.2 in combination with information derived from other sensors for locomotion planning. The end effector camera or cameras 570.2 may be utilized in similar ways or methods that are discussed within U.S. Patent Application Publication 2005/0267631 and U.S. Pat. Nos. 10,638,906, 10,437,251, 11,020,860, 10,580,208, 11,485,013, 11,759,075, or 10,614,588, all of which are incorporated herein by reference.

Other dimensions of said end effector sensor assembly 570 are described in the figures and in the below tables. It should also be understood that additional embodiments or alterations to said end effector sensor assembly 570 will be discussed below and said embodiments may be partially or fully combined with any of the above described embodiments. A detachably removable protective cover, such as a form-fitting glove, may be configured to overlie a majority of the end effector 56. This glove may have a palmer region, a dorsal region, a finger region, and a thumb region. The glove may further include a sensor region formed therein that does not cover or otherwise obstruct the field of view of the vision sensor 570.2. In some embodiments, the end effector 56 further includes a wrist actuator housing with a channel, and the protective cover or glove may be configured with an extent that is detachably secured to the channel.

ii. Finger Sensor Assemblies

The thumb and finger assemblies 564, 566a-566d each houses at least one tactile sensor assembly 568. The sensor assembly 568 is configured to measure the load experienced on the finger assemblies 566a-566d of the end effector 56. Additionally, or alternatively, the finger sensor assemblies 568 may also include cameras like the end effector camera 570.2. The sensor assembly 568 may be located in any one of (i) the proximal assembly 566.4, (ii) the medial assembly 566.6, (iii) the distal assembly 566.8 of each finger assembly 566a-566d, and/or (iv) a combination thereof. As shown in FIG. 23, the sensor assembly 568 is located in the distal assembly 566.8. In some embodiments, a sensor assembly 568 may be located in each of the proximal assembly 566.4, the medial assembly 566.6, and the distal assembly 566.8.

Each tactile finger sensor assembly 568 is configured to measure the load experienced on the thumb assembly 564 and/or finger assemblies 566a-566d of the end effector 56 using a strain gauge or arrays of strain gauges. The strain gauges measure strain, which may be used to determine the force, stress, torque, pressure, deflection, etc. experienced on the finger assemblies 566a-566d. The feedback provided by these tactile sensor assemblies 568 embedded in the finger assemblies 566a-566d can be combined with data from the encoders, torque sensors and/or other sensors that are positioned adjacent to or configured to obtain information from each joint. Said combination of feedback, data, and/or information can be used to control the actuation of the finger assemblies 566a-566d, thereby enabling robot 1 to perform complex manipulations that require delicate touch.

The tactile sensor assemblies (i) may be positioned at any location in the end effector (e.g., palm), wrist, foot, or end effector, (ii) may not be embedded in the assembly; instead, may be integrally formed therewith or directly secured to an outer extent of said assembly, (iii) may be formed in a layer or external covering (e.g., glove) that is positioned on top of or over said assembly, and/or (iv) a combination of any one of the described options. An example of possible combinations include: (i) a portion of the tactile sensor assembly positioned in the glove and a portion of the tactile sensor assembly embedded within the end effector, (ii) a portion of the tactile sensor assembly secured to the exterior of the housing of said end effector and a portion of the tactile sensor assembly embedded within the end effector, (iii) a portion of the tactile sensor assembly positioned in the glove, a portion of the tactile sensor assembly secured to the exterior of the housing of said end effector, and a portion of the tactile sensor assembly embedded within the end effector, (iv) a portion of the tactile sensor assembly positioned in the glove, a portion of the tactile sensor assembly integrally formed with the exterior of the housing of said end effector, and a portion of the tactile sensor assembly embedded within the end effector, and/or (v) any combination or hybrid thereof.

The strain gauges included in the tactile sensor assemblies may be any type of strain gauge including: (i) linear strain gauges, (ii) double linear strain gauges, (iii) shear or torsional strain gauges, (iv) rosette strain gauges (T (or Tee) shaped, rectangular shaped, delta shaped, stacked), (v) diaphragm strain gauges, (vi) biaxial strain gauges, (vii) bi-directional strain gauges, (viii) stacked strain gauges, (ix) cross strain gauges, (x) double shear, (xi) circular, (xii) any hybrid or combination thereof, and/or (xi) any other suitable strain gauge type that is known to one of skill in the art. The strain gauges may be arranged in different configurations including: (i) quarter-bridge configurations, (ii) half-bridge configurations, and/or (iii) full-bridge configurations.

The strain gauges may also be foil strain gauges, semiconductor strain gauges, thin-film strain gauges, ink based strain gauges, thick-film strain gauges, optical, nanocomposite, and/or any combination or hybrid thereof. Further, the strain gauges may be directly integrated into the housings (interior or exterior), coupled to said housings (interior or exterior) after the housing is manufactured, coupled to another structure (e.g., bridge, spring, etc.) positioned within the housing, integrated into or coupled to the motor or motor housing, positioned between housings, and/or any other known configuration or combination thereof. The foil strain gauges may be made from or include: (i) foils that may be or may include constantan (copper-nickel alloy), karma (nickel-chromium alloy), isoelastic (nickel-iron alloy), evanohm (nickel-chromium alloy), nichrome v (nickel-chromium alloy), and (ii) a carrier that may be or may include polyimide film, epoxy or phenolic resin, glass-fiber reinforced epoxy, ceramic backing, and/or polyurethane. Finally, the strain gauges may be any gauge that meets, uses, and/or was tested with at least one of the following standards: ASTM E251-13(2018), Standard Test Methods for Performance Characteristics of Metallic Bonded Resistance Strain Gages, ASTM International, ISO 376:2011, Metallic materials—Calibration of force-proving instruments used for the verification of uniaxial testing machines, ISO 9513:2012, Metallic materials—Calibration of extensometer systems used in uniaxial testing, VDI/VDE 2635 Blatt 2, Experimental structural analysis—Recommendation on the implementation of strain measurements at high temperatures, IEC 61298-3:1998, Process measurement and control devices—General methods and procedures for evaluating performance—Part 3: Tests for the effects of influence quantities, DIN 51301, which is hereby incorporated by reference for all purposes. The strain gauges may be used in combination with other sensors in the sensing assembly or at alternate locations in the robot. Other sensors or technology that may replace or be added to the tactile sensor assembles are discussed below.

### 5. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly 6 may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, and may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

Like the thumb and finger assemblies 564, 566a-566d, each foot assembly may include at least one sensor assembly. The sensor assembly is configured to measure the load experienced on the foot. Additionally, or alternatively, the foot assembly may also include cameras like the end effector camera 570.2. The sensor assembly may be located in the center of the foot, the proximal region of the foot, and/or the distal region of the foot.

### 6. Alternative Embodiments

In some embodiments, the manipulator includes a ring or cluster of emitters disposed about a palm-mounted imaging sensor, the emitters being driven with temporally coded sequences synchronized to the sensor's exposure timing. The temporal coding (e.g., mutually orthogonal bit patterns or chirped duty envelopes) enables the processor to demultiplex reflected light fields, reject ambient flicker from building LEDs, and attenuate view-dependent glare during contact and near-contact maneuvers. The controller selects a code family, frame budget, and duty ratio responsive to task state (approach, pre-load, closure) and environmental luminance, thereby improving feature-track stability and pose reconstruction without introducing any additional sensor modality beyond the existing camera.

In certain implementations, multiple low-profile LEDs are arranged around the palm camera at differing azimuth and elevation angles, and are strobed in sequence across successive frames to produce directionally distinct shading cues on the workpiece. The processor performs photometric stereo from the resulting image stack to estimate local surface normals and micro-geometry at the grasp site, improving contact placement and slip prediction especially for texture-poor objects. The system selects strobe order, intensity, and inter-frame timing to maintain compatibility with the camera frame rate and manipulator motion, thus providing high-fidelity shape cues without adding a new sensor class. In yet other embodiments, the palm illumination is configured to cycle through at least two polarization states (e.g., linear horizontal/vertical or left/right circular), and the camera is equipped with a fixed or switchable analyzer. By differencing images acquired under distinct emitter polarization states, the processor suppresses specular highlights and isolates diffuse reflectance components, which enhances edge and contour detection on highly reflective metals and liquids. The polarization schedule is coordinated with manipulator motion to preserve temporal coherence and may be adaptively disabled when ambient polarization is detected to exceed a threshold.

Some embodiments provide a removable fingertip or thumb pad comprising a transparent elastomer gel backed by a micro-patterned or speckled internal surface and viewed by a miniature internal imager. When the gel deforms against a contacted surface, the internal texture displacement and shading encode contact geometry with sub-millimeter resolution. The processor estimates shear, slip onset, and local curvature from these optical cues and fuses them with joint torque estimates to regulate grasp force, all while preserving compatibility with existing fingertip form factors. In certain variants, each fingertip includes a small permanent magnet embedded proximal to an array of Hall-effect sensors arranged to sense tangential field perturbations caused by lateral forces transmitted through the compliant skin. During manipulation of ferromagnetic or partially ferromagnetic parts, the sensed vector field changes correlate to shear and micro-slip at the contact patch, enabling early slip detection and re-grasp. The magnet strength, Hall spacing, and skin thickness are selected to maintain sensitivity without saturating under normal forces expected during industrial handling.

In another embodiment, a removable glove incorporates an interlaced micro-weave of optical fibers bearing distributed Bragg gratings (FBGs) at known intervals. Deformations of the glove during contact produce wavelength shifts that the interrogator converts into a sparse deformation field over the hand dorsum and palmar surfaces. A calibration map from fiber topology to glove surface coordinates allows reconstruction of contact shape and pressure distribution without embedding sensors in the rigid hand structure; the glove can thus be replaced or sterilized without recalibrating the robot's core sensors. Some embodiments include a miniature actuator at a fingertip configured to deliver low-energy, short-duration taps while the robot remains near or lightly contacting a surface, in coordination with one or more existing microphones on the platform. The processor analyzes the resulting impulse responses—e.g., resonance peaks, decay constants—to classify common materials (glass, polymer, wood) and to infer boundary conditions (hollow/filled). The tap amplitude and repetition rate are selected below thresholds that would disturb the object or violate safety constraints, thereby enabling non-destructive, sensor-minimal material identification.

In some implementations, each imaging and tactile acquisition device includes a hardware timestamp generator synchronized over a deterministic bus or Ethernet with IEEE-1588 or equivalent precision time protocol, yielding sub-millisecond or better inter-sensor alignment. The fusion pipeline consumes these timestamps to correct for motion-induced skew between asynchronous frames during rapid reaches, improving multi-view triangulation and contact timing. The system may periodically discipline the clock tree against a reference oscillator and report drift metrics for health monitoring. Certain embodiments integrate fiducial patterns inside the palm window and on wrist cuffs or forearm collars, positioned to be observable by head and wrist cameras through natural articulation. A scheduled set of calibration motions—e.g., arcs and figure-eights-causes each camera to image the fixtures at diverse poses, allowing the processor to estimate and update intrinsics, extrinsics, and hand-eye transforms without external targets. Triggering may occur at startup, post-service, or upon detecting reprojection error above a threshold, thereby maintaining alignment over the robot's lifecycle. In another embodiment, the motion planner includes a visibility predictor that propagates the robot's kinematic model and camera frusta forward in time to estimate impending self-occlusions of task-critical regions. If an occlusion is forecast during object approach or placement, the planner proactively re-poses the head or arm, or modifies the approach vector, to preserve at least one high-value line of sight while respecting collision and joint constraints. This predictive behavior reduces failures due to last-moment visual loss near contact.

Some embodiments employ an active perception policy that intermittently inserts micro-motions (“glances”) of the head or wrist to viewpoints predicted to maximize expected information gain over object pose, contact location, or state uncertainty, as computed from a belief representation. The policy balances estimation benefit against time and disturbance costs, selecting glance amplitude and dwell time to remain compatible with tight manipulation schedules. The result is improved pose convergence and grasp success with minimal runtime overhead. In certain variants, the system fuses per-pixel cues from the palm or wrist camera with fingertip contact patches to jointly estimate a 6-DoF object pose even when the hand occludes substantial object area. A factor-graph or filtering formulation couples photometric residuals with contact constraints derived from tactile sensing, allowing robust pose updates during finger closure and early lift. The fusion is conditioned on sensor confidence and automatically down-weights modalities experiencing slip or saturation.

Some embodiments implement a sealed optical window and housing for the palm camera having a rated ingress protection (e.g., IP67), combined with a hydrophobic/oleophobic coating and a membrane-based pressure equalization vent. The vent accommodates thermal expansion and altitude changes while maintaining the seal's integrity, reducing window bowing that would otherwise introduce focus shift and image distortion. Drain paths and debris lips may be molded into the bezel to shed liquids and particulates encountered in industrial environments. In certain configurations, heat generated by emitters and processing electronics proximate to cameras is routed via graphite sheets, vapor chambers, or heat pipes to thermally robust regions of the head shell. Thermal isolation features around the camera module maintain a stable sensor temperature, thereby reducing dark noise, fixed-pattern drift, and focus creep. The controller may modulate illumination duty and compute workload responsive to measured temperatures to preserve imaging quality during sustained operation.

In some embodiments, the grasp planner selects approach vectors, wrist orientations, and finger closure sequences that maintain at least one non-palm camera's view of the grasp site until a predefined closure milestone is reached. The planner evaluates candidate trajectories for predicted view quality using camera models and expected occluders (fingers, palm, workholding) and penalizes those that would prematurely blind the system. This sequencing reduces late-stage grasp failures and improves recovery options if slip is detected. In certain implementations, the vision controller monitors image statistics to detect mains-synchronous flicker bands and adjusts exposure, frame timing, and emitter duty cycles to avoid destructive aliasing with building lighting. The policy may lock frame intervals to non-harmonic values, gate exposures to inter-band windows, or switch to coded illumination modes during critical measurements. These adaptations are applied transparently to higher-level planners, yielding stable perception in warehouses and factories with heterogeneous luminaires. In another embodiment, during locomotion or task pauses the system periodically acquires short “background” keyframes from rear and top cameras and maintains an egocentric, short-term occupancy map of the nearby environment. If a retreat or back-step is commanded—e.g., following a human approach or imminent collision the controller can plan a safe reverse motion using this recently refreshed context without first re-scanning. The keyframe cadence and retention window are tuned to balance map freshness with compute and storage budgets.

ii. Degrees of Freedom

The high-level configuration of the robot 1 provides between 30 and 70 degrees of freedom (DoF), and preferably includes a total of 62 degrees of freedom provided by 42 rotary actuators. In particular, the 62 degrees of freedom are distributed within the illustrated embodiment of robot 1 as follows:
Upper Portion 2: 48 degrees of freedom (preferably above 50% of total DoF, most preferably above 65% of total DOF, and in the illustrated embodiment, approximately 77% of the total DoF)
   Head/Neck 10: 2 degrees of freedom (preferably below 5% of total DoF, preferably above 2% of total DoF, and in the illustrated embodiment approximately 3% of the total DoF)
   Each Arm Actuator (J1) 190: 2 degrees of freedom (preferably below 5% of total DoF, preferably above 2% of total DoF, and in the illustrated embodiment approximately 3% of the total DoF)
   Each Arm Assembly 5: 6 degrees of freedom (preferably below 12% of total DoF, preferably above 8% of total DoF, and in the illustrated embodiment approximately 10% of the total DoF)
      Each Upper Portion of the Arm Assembly: 3 degrees of freedom (preferably below 6% of total DoF, preferably above 4% of total DoF, and in the illustrated embodiment approximately 5% of the total DoF)
         Each Shoulder 26: 1 degree of freedom (preferably below 5% of total DoF, preferably above 1% of total DoF, and in the illustrated embodiment approximately 2% of the total DoF)
         Each Upper Humerus 30: 1 degree of freedom (preferably below 5% of total DoF, preferably above 1% of total DoF, and in the illustrated embodiment approximately 2% of the total DoF)
         Each Elbow: 1 degree of freedom (preferably below 5% of total DoF, preferably above 1% of total DoF, and in the illustrated embodiment approximately 2% of the total DoF)
      Each Lower Portion of the Arm Assembly: 3 degrees of freedom (preferably below 6% of total DoF, preferably above 4% of total DoF, and in the illustrated embodiment approximately 5% of the total DoF)
         Each Lower Forearm 46: 1 degree of freedom (preferably below 5% of total DoF, preferably above 1% of total DoF, and in the illustrated embodiment approximately 2% of the total DoF)
         Each Wrist 50: 2 degrees of freedom (preferably below 5% of total DoF, preferably above 2% of total DoF, and in the illustrated embodiment approximately 3% of the total DoF)
      Each End effector 56: 16 degrees of freedom (preferably below 50% of total DoF, preferably above 10% of total DoF and more preferably above 17% of total DoF, and in the illustrated embodiment approximately 26% of the total DoF)
         Each Finger: 3 degrees of freedom (preferably below 10% of total DoF, preferably above 2% of total DoF, and in the illustrated embodiment approximately 5% of the total DoF)
         Thumb: 4 degrees of freedom (preferably below 10% of total DoF, preferably above 2% of total DoF, and in the illustrated embodiment approximately 6% of the total DoF)
Central Portion 3: 10 degrees of freedom (preferably below 30% of total DoF, preferably above 10% of total DoF, and in the illustrated embodiment approximately 16% of the total DoF)
   Spine 60: 1 degree of freedom (preferably below 5% of total DoF, and in the illustrated embodiment approximately 1% of the total DoF)
   Pelvis 64: 1 degree of freedom (preferably below 5% of total DoF, and in the illustrated embodiment approximately 1% of the total DoF)
   Each Hip 70: 1 degree of freedom (preferably below 5% of total DoF, and in the illustrated embodiment approximately 1% of the total DoF)
   Each Upper Thigh 76: 2 degrees of freedom (preferably below 10% of total DoF, preferably above 2% of total DoF, and in the illustrated embodiment approximately 3% of the total DoF of the robot 1)
   Each Lower Thigh 80: 1 degree of freedom (preferably below 5% of total DoF, in the illustrated embodiment approximately 1% of the total DoF of the robot 1)
Lower Portion 4: 4 degrees of freedom (preferably below 10% of total DoF, preferably above 2% of total DoF, and approximately 6% of the total DoF)
   Each Shin 84: 1 degree of freedom (preferably below 5% of total DoF, and in the illustrated embodiment approximately 1% of the total DoF)
   Each Talus 88/Foot 92: 1 degree of freedom (preferably below 5% of total DoF, and in the illustrated embodiment approximately 1% of the total DoF)

The number and specific distribution of these degrees of freedom provide several significant advantages over conventional robots. For example, positioning more than 50%, preferably more than 65%, and most preferably more than 75% of the total degrees of freedom in the upper portion 2 of the robot 1 allows said robot 1 to perform highly dexterous tasks that could not be performed without a substantial majority of the degrees of freedom being concentrated in this upper portion. Additionally, minimizing the number of degrees of freedom within the central portion 3 enables the robot 1 to be designed with a larger internal torso volume, which allows for the inclusion of a larger battery pack and additional computing power, thereby improving performance and reliability. Finally, including less than 15% and preferably less than 10%, and/or approximately 6% of the total degrees of freedom within the lower portion 4 of the robot 1 beneficially minimizes the torque that is placed on the knees and hips during locomotion and manipulation tasks and allows the robot to minimize the time and number of steps for turning, which enables more humanlike movements and increases the speed at which certain tasks can be accomplished.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness to perform such a diverse array of generalized tasks.

i. Actuators

The actuators 1.2.4 contained within the robot 1 include thirty actuators (J1)-(J16), excluding the end effectors 56, that are housed within various components of the robot 1 to actuate movement of said components. An additional aggregate total of twelve actuators are in both end effectors 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment of robot 1. Specific actuators in each end effector 56 (e.g., six actuators in each end effector) are not individually included in the below table.

TABLE 1

| Actuator | Qty | Actuator Name | Informal Actuator Name(s) | Axis |
|---|---|---|---|---|
| (J1) 190 | 2 | arm | primary arm | A₁ |
| (J2) 280 | 2 | shoulder | (none) | A₂ |
| (J3) 320 | 2 | upper arm twist | upper arm x, upper arm roll | A₃ |
| (J4) 374 | 2 | elbow | arm z, arm yaw, | A₄ |
| | | | lower humerus | |
| (J5) 468 | 2 | lower arm twist | lower arm x, lower arm roll | A₅ |
| (J6) 484 | 2 | wrist flex | wrist/end effector y, wrist/end | A₆ |
| | | | effector pitch, flick | |
| (J7) 520 | 2 | wrist pivot | wrist/end effector z, wrist/end | A₇ |
| | | | effector yaw, wave | |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward kick | A₁₁ |
| (J12) 768 | 2 | hip roll | hip x, hip/leg roll, sideways kick | A₁₂ |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear kick | |
| (J15) 860 | 2 | foot flex | foot y, foot pitch, or first ankle | A₁₅ |
| (J16) 900 | 2 | foot roll | talus, foot roll, foot x, second ankle | A₁₆ |

| Actuator | Qty | Actuator Name | Informal Actuator Name(s) | Axis |
| : — | : — | : — | : — | : — |
| (J1) 190 | 2 | arm | primary arm | A1 |
| (J2) 280 | 2 | shoulder | (none) | A2 |
| (J3) 320 | 2 | upper arm twist | upper arm x, upper arm roll | A3 |
| (J4) 374 | 2 | elbow | arm z, arm yaw, lower humerus | A4 |
| (J5) 468 | 2 | lower arm twist | lower arm x, lower arm roll | A5 |
| (J6) 484 | 2 | wrist flex | wrist/end effector y, wrist/end effector pitch, flick | A6 |
| (J7) 520 | 2 | wrist pivot | wrist/end effector z, wrist/end effector yaw, wave | A7 |
| (J8.1) 120 | 1 | head twist | head no | A8.1 |
| (J8.2) 140 | 1 | head nod | head yes | A8.2 |
| (J9) 680 | 1 | torso lean | spine x, torso/spine roll | A9 |
| (J10) 620 | 1 | torso twist | spine z, torso/spine yaw | A10 |
| (J11) 720 | 2 | hip flex | hip y, hip/leg pitch, forward kick | A11 |
| (J12) 768 | 2 | hip roll | hip x, hip/leg roll, sideways kick | A12 |
| (J13) 782 | 2 | leg twist | hip z, hip/leg yaw | A13 |
| (J14) 820 | 2 | knee | lower thigh, lower leg y, lower leg pitch, rear kick | A14 |
| (J15) 860 | 2 | foot flex | foot y, foot pitch, or first ankle | A15 |
| (J16) 900 | 2 | foot roll | talus, foot roll, foot x, second ankle | A16 |

It should be understood that in other embodiments, some of these systems, assemblies, components, and/or parts may be omitted, combined, or replaced with alternative systems, assemblies, components, and/or parts. The robot 1 only uses electric actuators, and thereby lacks manual, hydraulic, cable-based, or pneumatic actuators. The exclusive use of electric actuators reduces assembly, maintenance, weight, and cost, and increases durability and safety considerations related to operating the robot 1 within or around other humans.

ii. Sensors

As illustrated in FIG. 3, sensors 1.2.8 may be embodied as any hardware, software, and/or circuitry for providing sensor data indicative of perceived stimuli, conditions, and measurements to enable the humanoid robot 1 to process, reason, and act appropriately (e.g., based on a given task, a set of rules, and/or other constraints). The sensors 1.2.8 may include one or more torque sensors 1.2.8.2, inertial sensors 1.2.8.4, visual sensors 1.2.8.6, auditory sensors 1.2.8.8, touch sensors 1.2.8.10, proximity sensors 1.2.8.12, environmental sensors 1.2.8.14, and other sensors 1.2.8.16. The sensors 1.2.8 may provide sensor data (e.g., torque, inertia measures, audiovisual sensor data, touch data, proximity data, environmental data, etc.) to the compute 1000 processors, further described below, to enable appropriate interaction between the humanoid robot 1 and the environment.

The torque sensors 1.2.8.2 may comprise one or more torque cells that are positioned within the actuators and are designed to measure the amount of force or torque applied to a part of the humanoid robot 1. The measurements may be transmitted to other components of the humanoid robot 1, such as the whole body controller 1550 or one or more controllers 1600, to enable balance, locomotion, manipulation, and handling by the humanoid robot 1.

The inertial sensors 1.2.8.4 may comprise sensors for measuring the motion, position, and orientation of the humanoid robot 1 relative to the environment for purposes of navigation, stabilization, and interaction with the environment and surroundings. For example, the inertial sensors 1.2.8.4 can include one or more accelerometers (e.g., to measure acceleration forces in one or more directions for use in determining changes in velocity and orientation), gyroscopes (e.g., to measure angular velocity for use in tracking rotational movement and maintaining balance), IMUs (e.g., combining the accelerometers and gyroscopes for use in providing comprehensive motion and orientation data), and Global Positioning System (GPS) receivers (e.g., to provide location data based on satellite signals, for use in outdoor navigation and positioning).

The visual sensors 1.2.8.6 may comprise sensors for capturing visual data, including cameras (e.g., red-green-blue (RGB) standard color cameras, grayscale monocular cameras, and stereo cameras (e.g., to capture depth perception)), depth cameras (e.g., depth cameras using technologies such as structured light or time-of-flight to measure distance to objects, Azure® Kinect® depth camera, Intel® RealSense® depth camera, etc.), LIDAR (Light Detection and Ranging) sensors (e.g., to measure distance to objects by emitting laser pulses, analyze the reflections, and provide detailed 2D or 3D maps of the environment), and radar (e.g., to detect objects via radio waves and measure distance and speed for use in various applications including navigation and obstacle detection). Visual sensors 1.2.8.6 may also include event-based cameras, which report changes in pixel intensity rather than full frames, offering advantages in speed and data efficiency for dynamic scenes. Examples of said visual sensors 1.2.8.6 include the cameras 108.2.2 and 108.2.4 contained in the head 10.1 of the robot 1.

The auditory sensors 1.2.8.8 may comprise sensors for capturing audio data, including microphones (e.g., to capture audio signals for voice recognition, environmental noise detection, or communication), ultrasonic transducers (e.g., to capture distance measurement and obstacle detection through high-frequency sound waves), and spatial audio sensors such as microphone arrays and direction of arrival sensors (e.g., to capture sound from different locations to determine the direction and distance of sound sources for 3D positioning). Auditory sensors 1.2.8.8 could also include specialized acoustic sensors for detecting specific sound patterns, such as the sound of failing machinery or distress calls, further enhancing the robot's environmental awareness.

The touch sensors 1.2.8.10 may comprise sensors for detecting physical contact or pressure applied to the surface of the humanoid robot 1, e.g., to enable tactile feedback, safety and collision avoidance, object handling and manipulation, and interaction with the environment and surroundings. Example touch sensors 1.2.8.10 may include pressure sensors to measure an amount of pressure applied to a surface by the humanoid robot 1, such as capacitive sensors (e.g., to detect touch or proximity through changes in capacitance), resistive sensors (e.g., to detect pressure or touch by measuring changes in resistance), piezoelectric sensors (e.g., to generate an electrical charge in response to mechanical stress or pressure and detect vibrations or impact), force-sensitive resistors (e.g., to change resistance based on the amount of applied force), and optical touch sensors (e.g., to use light beams or infrared to detect touches or proximity). Alternative touch sensors 1.2.8.10 may involve artificial skin technologies that provide a more distributed and nuanced sense of touch, capable of detecting not only contact but also shear forces and temperature changes on the robot's surfaces.

The proximity sensors 1.2.8.12 may comprise sensors for detecting the presence or absence of objects within a given range without necessarily making physical contact with the object, e.g., to provide obstacle avoidance, navigation, and object detection. Example proximity sensors 1.2.8.12 can include ultrasonic sensors (e.g., to measure distance by emitting ultrasonic waves and detecting reflection of the waves for avoiding obstacles and measuring distance) and infrared rangefinders (e.g., to detect, using infrared light, the presence or distance of objects for proximity sensing and simple obstacle detection). Capacitive proximity sensors may also be used as part of proximity sensors 1.2.8.12, particularly for close-range interactions.

The environmental sensors 1.2.8.14 may comprise sensors for measuring various physical parameters of the environment and surroundings to enable the humanoid robot 1 to interact with the environment and surroundings, adapt to changes in the environment and surroundings, and perform a given task. Example environmental sensors 1.2.8.14 can include thermocouples (e.g., to measure temperature by generating a voltage proportional to temperature difference), thermistors (e.g., to measure temperature based on changes in resistance), magnetometers (e.g., to measure magnetic fields for navigation and orientation), light sensors (e.g., to measure intensity of light in the environment), gas sensors (e.g., to detect presence and concentration of various gases and monitor air quality), and humidity sensors (e.g., to measure relative humidity in the air). Other environmental sensors 1.2.8.14 could include barometric pressure sensors for altitude determination or weather prediction, radiation sensors for operation in hazardous environments, or particulate matter sensors for air quality assessment in industrial settings.

iii. Communication Interfaces

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X. Specifically, FIG. 4 shows that the humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to effect such communication.

Referring to FIG. 4, examples of communication interfaces 1.2.12 include a wireless communication interface 1.2.12.2 (e.g., Bluetooth®, Wi-Fi®, WiMAX, Cellular (e.g., 3G, 4G, 5G), Zigbee, LoRa (Long Range) and RF (Radio Frequency)), a wired communication interface 1.2.12.4 (e.g., Ethernet, USB, Serial Communication (e.g., RS-232, RS-485), and Controller Area Network (CAN) interface)), a local communication interface 1.2.12.6 (e.g., an I2C (Inter-Integrated Circuit), SPI (Serial Peripheral Interface)), and a human-robot communication interface 1.2.12.8 (e.g., voice recognition systems to enable communication through spoken commands using speech recognition technology, touch interfaces such as touchscreens or physical buttons for direct human interaction with the humanoid robot 1). Alternatively or additionally, the human-robot communication interface 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in-boards, daughtercards, controller chips, chipsets, or other devices that may be used by the humanoid robot 1 for network communications with remote devices.

iv. Data Storage

Referring back to FIG. 2, the data storage 1.2.14 may be embodied as any hardware, software, or circuitry for storing, retrieving, and maintaining data for the humanoid robot 1. More particularly, the data storage 1.2.14 may be embodied as any type of device configured for short-term or long-term storage of data. The data storage 1.2.14 may be embodied as memory devices and circuits, solid state drives (SSDs), memory cards, hard disk drives, USB flash drives, or other data storage devices. The data storage 1.2.14 can be embodied as one or more SSDs that expose internal parallelism to components of the humanoid robot 1, allowing the humanoid robot 1, for example, via the compute 1000, to perform storage operations on the data storage 1.2.14 in parallel.

The data storage 1.2.14 may also include memory devices, which may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards, and similar standards, may be referred to as DDR-based standards and communication interfaces of the storage devices that implement such standards may be referred to as DDR-based interfaces.

The memory device may be a block addressable memory device, such as those based on NAND or NOR technologies. A memory device may also include a three dimensional crosspoint memory device (e.g., Intel® 3D XPoint® memory), or other byte addressable write-in-place nonvolatile memory devices. In an embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the device itself and/or to a packaged memory product. For data storage 1.2.14, a hierarchical storage architecture may be employed, using faster, smaller caches for frequently accessed data and larger, slower storage for archival or less critical data, optimizing both speed and capacity.

c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### E. Distances and Angles

TABLE 2

| Distance | Lower | Upper | Preferred Lower | Preferred Upper |
|---|---|---|---|---|
| (mm) | Bound | Bound | Bound | Bound |
| D1 | 163.28 | 244.92 | 183.69 | 224.51 |
| D2 | 71.336 | 107.004 | 80.253 | 98.087 |
| D3 | 80.136 | 120.204 | 90.153 | 110.187 |
| D4 | 67 | 100.5 | 75.375 | 92.125 |
| D5 | 63.92 | 95.88 | 71.91 | 87.89 |
| D6 | 163.696 | 245.544 | 184.158 | 225.082 |
| D7 | 157.728 | 236.592 | 177.444 | 216.876 |
| D8 | 112.848 | 169.272 | 126.954 | 155.166 |
| D9 | 100.632 | 150.948 | 113.211 | 138.369 |
| D10 | 92.024 | 138.036 | 103.527 | 126.533 |
| D11 | 138.592 | 207.888 | 155.916 | 190.564 |
| D12 | 151.728 | 227.592 | 170.694 | 208.626 |
| D13 | 61.376 | 92.064 | 69.048 | 84.392 |
| D14 | 164.448 | 246.672 | 185.004 | 226.116 |
| D15 | 38.4 | 57.6 | 43.2 | 52.8 |
| D16 | 102.32 | 153.48 | 115.11 | 140.69 |
| D17 | 63.792 | 95.688 | 71.766 | 87.714 |
| D18 | 35.096 | 52.644 | 39.483 | 48.257 |
| D19 | 64.76 | 97.14 | 72.855 | 89.045 |
| D20 | 141.688 | 212.532 | 159.399 | 194.821 |
| D21 | 3.912 | 5.868 | 4.401 | 5.379 |
| D22 | 140.976 | 211.464 | 158.598 | 193.842 |
| D23 | 7.232 | 10.848 | 8.136 | 9.944 |
| D24 | 26.688 | 40.032 | 30.024 | 36.696 |

TABLE 3

| Angle | Lower | Upper | Preferred Lower | Preferred Upper |
|---|---|---|---|---|
| (Degrees) | Bound | Bound | Bound | Bound |
| A1 | 57.6 | 86.4 | 64.8 | 79.2 |
| A2 | 66.04 | 99.06 | 74.295 | 90.805 |
| A3 | 77.96 | 116.94 | 87.705 | 107.195 |
| A4 | 86.4 | 129.6 | 97.2 | 118.8 |
| A5 | 46.344 | 69.516 | 52.137 | 63.723 |
| A6 | 59.728 | 89.592 | 67.194 | 82.126 |

### F. Alternative Embodiments

In other embodiments, other portions of the robot 1 may have camera sensors mounted thereto to provide a fuller field of view. For example, the robot 1 may have cameras on (i) the torso 16, (ii) the legs 6, and/or (iii) the feet 92. The torso 16 may have camera sensors that view the front and the rear of the robot 1. The torso cameras may be positioned near the spine 60 or near the head and neck assembly 10 of the robot 1. The torso cameras may be angled relative to the sagittal plane in a left or right direction and/or angled relative to the horizontal plane or transverse plane in an upward or downward direction. In some embodiments, the legs 6 or feet 92 of the robot 1 may have camera sensors that view the front and the rear of the robot 1. Similarly, the robot's feet 92 may have cameras that view the front and the rear of the robot 1.

It should be understood that other sensors and/or technology may be used instead of or in combination with the sensor assemblies discussed above. Other strain gauge technology that may be used includes: (i) mems-based strain gauges, (ii) nanocomposite strain gauges, (iii) thin-film or thick-film strain gauges (e.g., C4A Series or EA Series from Vishay Precision Group, RF9 Series or Y Series from Hottinger Bruel & Kjor, KFG Series or KFR Series from Kyowa Electronic Instruments, TFSG Series from BCM Sensor Technologies, SGT Series or KFH Series from Omega Engineering, ELF Series or EPL Series from Meggitt Sensing Systems, or any other known manufacturer), (iv) inductive strain gauges, (v) capacitive strain gauges, (vi) piezoelectric strain gauges, (vii) optical fiber strain gauges, (viii) semiconductor strain gauges, and/or (ix) a hybrid or combination thereof. The strain gauges provide measurements with high accuracy, but may lack high resolution. The additional sensors used in combination with the strain gauges in the sensor assembly would help provide a higher resolution. Alternative or additional sensors/technology may include photodiodes, Hall Effect sensors, capacitive sensors, piezoelectric sensors, piezoresistive sensors, optical sensors, force-sensitive resistors (FSRs), magnetic sensors, inductive sensors, micro-electro-mechanical systems (MEMS) sensors, dielectric elastomer sensors, quantum tunneling composite (QTC) sensors, fiber Bragg grating sensors, ultrasonic sensors, thermal sensors, electroactive polymers, triboelectric nanogenerators (TENGs), linear variable differential transformers (LVDTs), flex sensors, acoustic emission sensors, resistive touch sensors, proximity sensors, hydrogel-based sensors, smart skin technologies, magnetoelastic sensors, capacitive micromachined ultrasonic transducers (CMUTs), pressure-sensitive adhesives, electromagnetic acoustic transducers (EMATs), photonic crystal sensors, laser doppler vibrometers, electrical impedance tomography sensors, graphene-based sensors, nanowire sensors, electronic skin (e-skin) sensors, carbon nanotube-based sensors, barometric pressure sensors, eddy current sensors, microfluidic tactile sensors, nanogenerators, stretchable electronic sensors, force torque sensors, rheological sensors, haptic feedback sensors, polymer nanofiber sensors, ionic liquid-based sensors, thermocouple sensors, touch-sensitive field-effect transistors, terahertz radiation sensors, radar sensors, LIDAR sensors, infrared touch sensors, humidity sensors, mechanical limit switches, pressure mapping sensors, distributed fiber optic sensors, magnetostrictive sensors, optoelectronic sensors, surface acoustic wave (SAW) sensors, capaciflectance sensors, tribo-skin sensors, spintronic sensors, photonic touch sensors, acoustic resonant sensors, and capacitive tomography sensors, or any other suitable technology that is known to one of skill in the art.

### G. Industrial Application

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or end effector assembly 56” indicates that the structure that is referenced by the number 56 can be referred to or claimed as either an “end effector” or an “end effector assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 18/922,334, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/306,591, 19/319,712, 19/324,392, 19/323,751, 19/325,486, 19/325,415, 19/324,342, 19/329,008, 19/329,474, 19/329,485, 19/329,559, 19/337,845, 19/337,852, 19/337,899 and 19/355,393; and (iii) U.S. Design Patent Application Nos. 29/889,764, 29/928,748, 29/935,680, 29/954,572, 29/967,462, 29/993,115, 29/998,761, 30/024,341, and 30/024,351; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A bipedal robot comprising:
a torso;
a head coupled to the torso;
an arm assembly coupled to the torso at a proximal end of the arm assembly; and
an end effector coupled to the arm assembly at a distal end of the arm assembly, wherein the end effector has a palmer side and a dorsal side and includes:
a thumb assembly having at least three degrees of freedom,
a first finger assembly having at least two degrees of freedom,
a vision sensor positioned between a distal end of the arm assembly and the first finger assembly, and
an illumination source arranged to illuminate at least a majority of the field of view between: (i) the vision sensor and, (ii) the extent of the thumb and the extent of the first finger assembly, as determined while the humanoid robot is in an extended state; and
wherein the vision sensor is configured to have a field of view that includes a majority of the palmer side of said end effector, and whereby said field of view enables the vision sensor to detect information about contact between an object and one or more of: (i) an extent of the thumb assembly, and (ii) an extent of the first finger assembly.

2. The bipedal robot of claim 1, wherein the end effector is coupled to the arm assembly via a wrist, and wherein the vision sensor is oriented on the palmer side and positioned at the wrist.

3. The bipedal robot of claim 1, wherein at least one of the thumb assembly and the finger assembly includes a tactile sensor comprising a strain gauge at a distal end of the thumb assembly and/or a distal end of the finger assembly.

4. The bipedal robot of claim 1, further comprising a detachably removable protective cover configured to overlie a majority of the end effector but not obstruct the field of view of the vision sensor.

5. The bipedal robot of claim 4, wherein the end effector further includes a wrist actuator housing with a channel, and wherein the protective cover is configured as a glove with an extent of the glove detachably secured to the channel.

6. The bipedal robot of claim 1, wherein the vision sensor comprises a first imaging detector, and wherein the head includes a second imaging detector that is identical to the first imaging detector.

7. The bipedal robot of claim 1, wherein the information about contact is used, at least in part, to control movement of the first finger assembly and movement of the thumb assembly.

8. A bipedal robot comprising:
a torso;
a head coupled to the torso;
an arm assembly coupled to the torso; and
an end effector coupled to the arm assembly, wherein the end effector includes:
a first finger assembly having: (i) a respective operational space, (ii) a first energy attenuation member affixed to a portion of the first finger assembly,
a thumb assembly positioned adjacent to the first finger assembly and having: (i) a respective operational space, (ii) a second energy attenuation member affixed to a portion of the thumb assembly, and
a vision sensor positioned near both the thumb assembly and the finger assembly and having a field of view that includes the respective operational space of the first finger and at least a majority of the respective operational space of the thumb.

9. The bipedal robot of claim 8, wherein the end effector has: (i) a proximal end at which the end effector is coupled to the arm assembly, and (ii) a first side towards which the finger assembly is configured to curl, wherein the vision sensor is positioned between the proximal end of the end effector and the first finger assembly and the field of view includes at least a portion of the first side of the end effector.

10. The bipedal robot of claim 8, wherein the end effector further includes an illumination source arranged to illuminate at least a portion of the respective operational space of the first finger assembly and at least a portion of the respective operational space of the thumb.

11. The bipedal robot of claim 8, further comprising a form-fitting glove with a palmer region, a dorsal region, a finger region, and a thumb region, wherein the form-fitting glove is detachably positioned over at least a portion the end effector, wherein the form-fitting glove has a sensor region formed therein that does not cover the vision sensor.

12. The bipedal robot of claim 8, wherein end effector further includes a control assembly configured to control motion of the first finger assembly and motion of the thumb assembly.

13. The bipedal robot of claim 8, wherein, as determined while the humanoid robot is in an extended state, the vision sensor is positioned at a downward-facing angle of about 45 to about 70 degrees with respect to a horizontal plane (PH), wherein the horizontal plane is parallel to a transverse plane of the humanoid robot and extends through the vision sensor.

14. The bipedal robot of claim 8, wherein, as determined while the humanoid robot is in an extended state, the vision sensor is positioned at a downward-facing angle of about 12 to about 19 degrees with respect to a vertical plane (PV2), wherein the vertical plane is parallel to a coronal plane of the humanoid robot and extends through the vision sensor.

15. The bipedal robot of claim 8, wherein the end effector includes a palm surface, and wherein the vision sensor is coupled to the palm surface.

16. The bipedal robot of claim 8, wherein the humanoid robot uses information derived from the vision sensor in combination with information derived from other sensors for locomotion planning.

17. A bipedal robot comprising:
a torso;
a head coupled to the torso;
an arm assembly coupled to the torso; and
an end effector coupled to the arm assembly, wherein the end effector includes:
a thumb assembly coupled to a first portion of the end effector,
a first finger assembly coupled to a second portion of the end effector,
a sensor mounting frame coupled to a third portion of the end effector that is positioned between a distal extent of the arm and a majority of the first finger assembly, and
a vision sensor mounted to the sensor mounting frame and including:
an imaging detector,
a lens that overlies and protects the imaging detector, and
an illumination source positioned near the image detector and configured to illuminate a spatial region between the imaging detector and a distal end of the first finger assembly.

18. The bipedal robot of claim 17, wherein the end effector includes a palmer side and a dorsal side, and wherein the vision sensor is coupled to the end effector on the palmer side of the end effector.

19. The bipedal robot of claim 17, wherein at least one of the thumb assembly and the finger assembly includes a tactile sensor comprising a strain gauge at a distal end of the thumb assembly and/or a distal end of the finger assembly.

20. The bipedal robot of claim 17, further comprising a detachably removable protective cover, wherein the protective cover is configured to overlie a majority of the end effector but not overline the lens of the vision sensor.

21. The bipedal robot of claim 20, wherein the protective cover is configured as a glove with an extent of the glove detachably secured to the end effector.

22. The bipedal robot of claim 17, wherein the vision sensor comprises a first imaging detector, and wherein the head includes a second imaging detector that is identical to the first imaging detector.
